(19) United States
(12) Patent Application Publication
(10) Pub. No.: US 2012/0290978 A1
(43) Pub. Date: Nov. 15, 2012

(54) SYSTEM AND METHOD FOR AN INTERACTIVE MOBILE-OPTIMIZED ICON-BASED SINGLES AND DATING PROFILE DISPLAY AND ASSOCIATED SOCIAL NETWORK FUNCTIONALITY

(76) Inventor: John Devecka, Pleasanton, CA (US)

(21) Appl. No.: 13/471,212

(22) Filed: May 14, 2012

Related U.S. Application Data
(60) Provisional application No. 61/485,443, filed on May 12, 2011.
(60) Provisional application No. 61/548,499, filed on Oct. 18, 2011.
(60) Provisional application No. 61/588,552, filed on Jan. 19, 2012.

(51) Int. Cl. G06F 3/048

(52) U.S. Cl. 715/810

(57) ABSTRACT

An icon-based interactive singles and dating profile, search and matching system and method configured within singles' social network platforms and technologies enabling a user to generate a personalized interactive icon-based profile representing various icon profile elements optimized for display and functionality on mobile devices. The icon profile system utilizes and integrates selected personalized icon profile elements and associated data for searching, compatibility matching, invitations, communities, services, advertisements and calendar functions. In singles and dating social network environments icon elements are unitized to aggregate users based on a selected common icon profile element and in further environments automatically compare and report compatibility between unknown users, which vastly improves dating network functionality.

### CROSS-REFERENCE TO RELATED APPLICATIONS

This application claims the benefit of U.S. Provisional Application No. 61/485,443, filed May 12, 2011, U.S. Provisional Application No. 61/548,499, filed Oct. 18, 2011, and U.S. Provisional Application No. 61/588,552, filed Jan. 19, 2012, each of which are hereby incorporated by reference herein in their entireties.

### FIELD OF THE INVENTION

Embodiments of the present disclosure relate to the field of mobile and internet-based singles and dating sites and social networks. More specifically, the present invention relates to a mobile optimized icon-based profile system and dating network including an interactive icon-based profile system with an associated search, compatibility, matching, services, and communication system as well as an associated social network system and environment based on icon profile elements.

### BACKGROUND OF THE INVENTION

Dating websites, social networks and mobile applications have become a pervasive tool used by many people to search for and identify a potential romantic partner. Conventional dating network platforms encourage strangers to meet one another for a potentially romantic one-on-one encounter based on an initial matching within an online environment. Although conventional dating network applications are widely used, the community features, compatibility technologies, and social norms of these applications are limited.

For example, conventional dating network systems are limited in that dating-related matches are identified and coordinated by the systems based on relatively superficial profiles containing high-level free form text narrative information relating to the underlying users. Other one-on-one search services require an extensive and time consuming survey taking method in which results are used by matching algorithms for determining a list of potentially compatible candidates. The user must further read the associated user's standard text narrative profile. These systems allow users to establish dating profiles which lack certain elements, capabilities and underlying functionality which would provide more depth and new functionality to a singles profile and improved match results. These sites further lack profile integrated singles social networking communities, activities, services and singles friendship opportunities. The limited dating profiles and site structure offered by conventional systems further limit singles' social networking and entertainment options and limits the ability for a user to efficiently identify all compatible and appropriate connections within the dating networking environment.

Further social limitations exist in popular conventional online and mobile social network environments and technologies, especially text and video chat rooms, social forums and social gaming networks, few personal facts or commonalities about other users are known beyond the associated screen name and or profile picture, severely limiting the technology's potential social usefulness.

Furthermore, dating applications lack easy-to-read singles profiles configured to communicate a large quantity and depth of relevant information to a viewer in an efficient manner, especially on mobile devices. In addition, conventional dating profiles are substantially composed of text-based descriptions entered by a user. Since each user is free to write the descriptions in his or her profile in any way he or she chooses, there is a lack of consistency, uniformity, and readability among the dating profiles maintained by the dating system. A considerable amount of time is required to read and comprehend each profile narrative which reduces the amount of singles profiles a user may view and evaluate in a given amount of time. In addition, text-based profiles inherently possess language-based barriers for users who are not able to read and understand the language of another user's profile.

As such, current dating networking platforms do not offer an efficient system or method for establishing a dating-related network by identifying potential romantically-compatible users based on a commonality and mutual preferences between the users' interests, background, activities, goals, likes, dislikes, personality traits, and skill sets. In addition, conventional dating applications lack a general “singles” community experience and an integrated icon activity based services network that may promote and enhance the formation of friendships among all singles as a community type which in some cases may lead to a romantic relationship.

Therefore a need exists in the art for a system configured to accurately and efficiently profile, present search, view, and form matches based on compatibility with other singles based on shared interests, preferences and activities. Further a need exists to easily locate order, coordinate and manage offers from service providers based on a user's activities and preferences. Lastly, a need exists to provide all “singles” with an activities and interest directed social network environment which provides further romantic and actual friendship and activity networking opportunities to all singles as a community type.

### BRIEF SUMMARY OF THE INVENTION

A system and method are presented for enabling a user to create a customizable icon-based singles, singles friendships and dating, herein referred to as a “dating” profile representing the user's personal information, professional information, physical attributes, personality traits, interests, and/or activities and utilize the icon-based dating profile to identify and connect with other potentially single or romantically-compatible users in a dating network environment. In an embodiment, the format and content of an icon-based dating profile may be generated and customized based on one or more genres of the dating network selected by a user. Exemplary dating network genres, according to embodiments of the present invention, including but are not limited to singles communities sorted by a demographic such as “Over 50”, or “Professionals” or a certain religious affiliation, an established singles activities network, established dating network, and/or established dating community genre; an icon-based singles activities and/or dating environment genre; an icon-based dating-focused travel and leisure services genre, etc.

According to an embodiment of the present invention, the icon-based dating network system and method (also referred to herein as the “dating network icon system”) is configured to maintain multiple icons (e.g., a library or pallet of icons), each representing a dating profile element. The dating network icon system is further configured to receive a selection of one or more icons from a user and generate a dating profile for the user based on the selected icon(s).

In one or more embodiments of the present invention, the dating network icon system provides additional customized and auto-generated compatibility results or user-to-user matching based on icon compatibility, a location-based parameter or preference (e.g., an identified “zone” or geographic proximity relative to a selected location), and/or other matching criteria. As used herein, the term “zone” includes, without limitation, a defined geographic region, a place (e.g., a bar/restaurant, a college campus, etc.) or location (e.g., city, county, state) or a region defined by a certain radial distance from a given point (e.g., a 10 mile radius from point A). In an embodiment, a user's zone may represent a geographic region or radius based on the user's home, current location, or other specified location (e.g., a planned destination such as a travel location or a new residence).

In an embodiment, the dating network icon system provides multiple users with a graphical user interface (or GUI) including a series of icons from which to select in generating an icon-based dating profile. An icon may include, but is not limited to, an image, a picture, a video, or other visual indicator representing a dating profile element. As used herein, a dating profile element is intended to include any personality trait of the user, group, singles friend, or romantic candidate (e.g., dating-related trait), interest, hobby, skill, ambition, preference, taste, award, attribute, statistic, certification, education, experience, biographical data, goal, personal characteristic, dating-related characteristic, etc. that may be selected by a user for inclusion in the user's dating profile including icons for posted preferences and requirements. In an embodiment, a user may generate a dating profile including multiple icons relating to dating profile elements, such as, for example, the user's activities, skills, residence information, prior dating experience, educational background, physical characteristics, achievements, certifications, compatibility factors, etc.

According to embodiments of the present invention, multiple icons having one or more common single's-centric: user, friend, and dating candidate attributes may be maintained and grouped into one or more icon categories. Exemplary icon categories include, but are not limited to, a dating trait category, a dating experience category, a community interest category, a favorite dating activities category, an activities category, single friends activities, an events category, a favorite dating groups category, a favorite dating location category, an entertainment category, a lifestyle category, an interests category, an appearance, a music category, a profession category, an affiliation category, an education category, an athletics category, a hobbies category, etc. In generating a singles and dating profile, the user may navigate the dating network icon system using the icon categories in order to identify the one or more icons to select for inclusion in his or her dating profile.

In an embodiment, the dating network icon system enables a user to associate one or more secondary descriptors with a selected icon (i.e., an icon selected by a user for inclusion in the user's icon-based profile). A secondary descriptor may be any information linked or associated with an icon which is used to further define or describe a user's relationship with the underlying dating profile element associated with the icon. According to embodiments of the present invention, the secondary descriptor may be a “secondary” icon associated with a primary icon (e.g., a primary icon representing an “athlete” dating profile element may have associated therewith a secondary icon representing a “runner”, a “basketball player”, or a “yoga practitioner”), a text-based description, a requirement, a preference, a rating, or any other expression which enriches, augments, and/or expands on a user-selected icon.

In an embodiment, a user may identify one or more icons from his or her dating profile as a priority icon for dating and single friends. The one or more priority icons selected by a user may be organized into a “billboard” or a second hidden or viewable profile representing important or required dating or singles friendship profile elements associated with the user. For example, a user having a dating profile including fifty icons may select eight icons as priority icons (i.e., dating profile elements which are most representative or best define the user) and include those eight icons in the user's billboard. In an embodiment, a user's billboard may be the top-level display (e.g., initially displayed by the dating network icon system when encountering a user) associated with the user.

According to embodiments of the present invention, each of the multiple icons maintained by the dating network icon system are linked to search terms, tags, keywords, associations, compatibility associations, and/or user tags for use in matching users of the dating network icon system according to various matching methodologies.

Advantageously, the use of icons to create icon-based dating profiles and the dating profile creation process of the present invention achieve a consistent and robust presentation of a user and his or her personal information. Accordingly, embodiments of the present invention overcome constraints and barriers associated with conventional virtual and real-life dating environments. The dating network icon system allows users to identify, form and maintain a connection to an online singles and dating-focused community based on the user's own dating profile elements. As a result, the dating network icon system enables new in-person relationship development and/or romantic opportunities and capabilities among otherwise un-connected users having highly compatible profiles, preferences, requirements, (e.g., compatible dating experiences, dating interests, social schedules, activities, hobbies, aspirations, goals, physical attributes, proximity, etc.). Furthermore, the system may match a user's icon elements against a database of other users with similar profile elements and provide statistically based recommendations of alternate, potentially compatible profile elements (for romantic and/or single friend connections), activities, groups and other profile elements that the user may want to try in order to further promote new quality connections.

According to embodiments of the present invention, a user's icon-based dating profile may be integrated and/or transported for use in other system-defined or third party environments. For example, a dating profile may be employed (e.g., used to represent a user) in one or more of: an environment focused on identifying new singles and dating opportunities or romantic relationships; an icon-specific community (e.g., a “fitness” community including other users sharing a common interest in fitness); a clique or group of users matched based on a similarity of their respective dating profiles; establishing a social calendar; and/or an external dating web service, network, or environment (collectively referred to as an “external environment”). Exemplary external environments in which the icon-based dating profile may be used to represent a user include, but are not limited to, a video and/or media broadcasting community, an event-based network, an activity based network, an existing social network (e.g., Facebook), a travel and/or leisure web service, a social gaming network, a video and/or text chat platform, a retail and/or user marketplace, or an existing dating network (e.g., E-harmony®). In this regard, the icon-based dating profile is a transportable dating profile that may be used to represent a user in any number of other internet and mobile based contexts and environments.

In embodiments of the present invention, the dating network icon system may be configured to allow businesses, individuals and/or advertisers to promote goods, activities, events, and/or services to users, groups or icon communities. The icon system integrated advertiser services provide dating and activity options, conveniences, dating process continuity, and new social opportunities to users and user groups. In an embodiment, advertisements and/or promotions may be directed to users of the dating network icon system with icon system integrated features such as group, purchasing, calendar and invitation functions and such offers are based on a user's and or candidates singles and dating profile, dating activity needs and preferences, user site and activity usage history, specific dating profile elements, business cliques, events, groups, etc. Advantageously, advertising efficacy and mutual user and advertiser benefits are realized by the dating network icon system since a user's icon profile represents user-specified, highly specific personal data regarding the user's dating profile elements (e.g., interests, activities, preferences, personality traits, fantasy attributes, travel, dining, pop culture media, celebrity news, habits, activity and singles groups, similar celebrity traits to the user, favorite dating places, and other icons specific to dating culture, theory and key matching criteria).

According to embodiments of the present invention, the dating network icon system generates interactive icon-based dating profiles that allow a viewer to inquire and learn additional information about particular traits, preferences, likes, dislikes, ideals, morals, family preferences and/or characteristics represented by an icon in the icon-based profile.

In an embodiment, the format of the icon-based dating profile may be configured and/or customized by the user. In this regard, the manner in which a user selects the format of the dating and candidate profile and the icons for inclusion in the dating profile produce a basis for review and evaluation of the user's personality, creativity, passion level, etc. In an embodiment, viewers may also publicly or privately rate a user's dating profile or experience. This data may be used in many ways including effecting placement in search results. In another embodiment, only the user who created the dating profile may view the profile feedback provided by the community. In an embodiment, a user's dating profile and status may be easily updated and altered based on scheduled events, scheduled dates, dating status changes, achievements, and geographic data.

According to embodiments of the present invention, the icon-based dating profile enables a user to view an icon-based compatibility listing in an efficient manner, without having to read lengthy and non-uniform text-based descriptions. In this regard, icon-based matching results allow a user to view the icons and form a top line or high-level compatibility assessment, and further obtain more detailed/complex descriptions of another user if he or she desires.

According to embodiments of the present invention, the dating network icon system provides for faster dating profile comprehension of user and candidate requirements, comparison and compatibility. Viewing and comprehending a user's icon profile is especially efficient in a mobile application wherein the mobile device has a limited display size. According to embodiments of the present invention, dating compatibility results may be interpretive and algorithm-based, wherein users may be matched based on various methods of compatibility theories derived from user profile data, for example, the users' birth sign compatibility. In an embodiment, the dating network icon system may administer an icon-based survey or test for use as criteria in determining potential matches and present icon profile element based results. In addition, the survey or test may be used to create dating profiles.

In an embodiment, for any icon dating profile community, a user may select from a list of dating network icon system-generated compatibility presets and sorts (e.g., system-generated icon-to-icon associations, user or candidate perspective preferences or requirements, or user to user trait compatibility matches). In an embodiment, the dating network icon system promotes group and/or one-on-one activity scheduling and may present offers and discounts from local concierges and advertisers allowing users to realize discounts based on their dating activities. In addition, scheduling, booking and arranging singles-related activities may be performed via the icon-based social calendar of the dating network icon system.

In additional embodiments, computing devices for performing the operations of the above described embodiments are also implemented. Additionally, in embodiments of the invention, a computer-readable storage media stores methods for performing the operations of the embodiments described in the present application.

### BRIEF DESCRIPTION OF THE DRAWINGS

The present disclosure will be understood more fully from the detailed description given below and from the accompanying drawings of various embodiments of the disclosure.

FIG. 1 illustrates an exemplary arrangement of associated icons maintained by the dating network icon system, according to embodiments of the present invention;

FIG. 1A illustrates an exemplary arrangement of a primary icon and associated secondary icons, according to embodiments of the present invention;

FIG. 2 is a diagrammatic representation of a workflow illustrating an exemplary genre-based dating profile creation process, according to embodiments of the present invention;

FIG. 3 illustrates exemplary interface of an icon-based single friends and dating network system displaying an icon-based dating profile associated with a first user including exemplary secondary descriptors, according to embodiments of the present invention;

FIG. 4 illustrates an exemplary interface of a mobile device application of an icon-based single friends and dating network system, according to embodiments of the present invention;

FIG. 5 illustrates an exemplary process flow for generating an icon-based dating profile, according to embodiments of the present invention;

FIG. 6 illustrates an exemplary interface of an icon-based dating network system displaying a dating profile creation tool, according to embodiments of the present invention;

FIG. 7 illustrates an exemplary process flow for generating a customized icon-based dating profile including secondary preferences according to embodiments of the present invention;

FIG. 8 illustrates an exemplary interface of an icon-based dating network system displaying secondary descriptors associated with an icon, according to embodiments of the present invention;

FIG. 9 illustrates an exemplary interface of an icon-based dating network system displaying an exemplary user-generated icon process, according to embodiments of the present invention;

FIG. 10 illustrates an exemplary interface of an icon-based dating network system displaying an exemplary “smart clique” user group creator tool, according to embodiments of the present invention;

FIG. 11 illustrates an exemplary process flow for searching within an icon-based dating network system, according to embodiments of the present invention;

FIG. 12 illustrates an exemplary interface of an icon-based dating network system displaying exemplary search results returned by the icon-based dating network system in response to a user search, according to embodiments of the present invention;

FIG. 13 illustrates an exemplary interface of an icon-based dating network system displaying an exemplary icon-based community or clique, according to embodiments of the present invention;

FIG. 14 illustrates an exemplary interface of an icon-based dating network system displaying exemplary search results returned by the icon-based dating network system in response to a search including secondary descriptor criteria, according to embodiments of the present invention;

FIG. 15 illustrates an exemplary interface of an icon-based dating network system displaying an exemplary icon-based social calendar, according to embodiments of the present invention;

FIG. 16 illustrates an exemplary interface of an icon-based dating network system displaying an exemplary invitation and chat associated with an event, according to embodiments of the present invention;

FIG. 17 illustrates an exemplary process flow for using a generated icon-based dating profile in multiple dating network environments, according to embodiments of the present invention;

FIG. 18 illustrates an exemplary interface of an icon-based dating network system displaying an exemplary icon-based community, according to embodiments of the present invention;

FIG. 19 illustrates an exemplary interface of an icon-based dating network system displaying an exemplary icon-based video chat, according to embodiments of the present invention;

FIG. 20 illustrates an exemplary interface of an icon-based dating network system displaying an exemplary gaming environment, according to embodiments of the present invention;

FIG. 21 illustrates an exemplary process flow for creating and/or delivering a concierge service or advertisement in the icon-based dating network system, according to embodiments of the present invention;

FIG. 22 illustrates an exemplary interface of an icon-based dating network system displaying an exemplary advertisement creation and delivery tool, according to embodiments of the present invention;

FIG. 23 illustrates an exemplary interface of an icon-based dating network system displaying an exemplary advertising delivery tool, according to embodiments of the present invention; and

FIG. 24 illustrates is a block diagram of an exemplary computer system that may perform one or more of the operations described herein.

### DETAILED DESCRIPTION

An icon-based single friends and dating networking system (or “dating network icon system”) configured to provide an efficient, effective, and enjoyable dating network platform for multiple users. The dating network icon system may be configured in various ways, including, for example, as a stand-alone web site with multiple singles community genre categories including a mobile application or within established dating network programs, blogs, video chats, other sites, or communities to quickly and efficiently promote personal attribute awareness and increase peer to peer communication, activity and understanding. The dating network icon system uses icons to enhance profile reading efficiency, user communication and network growth, such as via an API interface or by direct integration of a customized icon profile software module.

A user may create a dating profile including multiple icons (i.e., an icon-based dating profile). Each icon represents a user or candidate singles friendship or dating profile element and may be actionable to permit connection, peer communication, activities, group communication, ratings, formation of communities, invitations, and dialog associated with the dating profile element underlying the icon.

According to embodiments of the present invention, the dating network icon system includes one or more computing devices configured to perform the steps, functions, actions, features, processes, communications, activities, etc. described throughout the present application. In embodiments of the present invention, the one or more computing devices configured to implement the dating network icon system may operate within a single computing device (e.g., a server) or on multiple computing devices.

The dating network icon system may comprise any number of computer components (e.g., computer-implemented instructions, programs, scripts, etc.) implemented together in a single device or networked in various combinations of multiple different devices that operate together. Examples of a computing device that may be configured to implement the icon-based dating network include, but are not limited to, a server, a mainframe computer, a networked computer, a process-based device, and similar type of systems and devices. The network may include the Internet in one embodiment. In other embodiments, other networks, wired and wireless, such as an intranet, local area network (LAN), wide area network (WAN), or broadcast network may be used.

The dating network icon system and its associated computing platform are configured to communicate with multiple users operating a suitable user device via a suitable network. The user device may be any type of computing device, for example, any data processing device, such as a desktop computer, a laptop computer, a mainframe computer, a personal digital assistant, a server, a handheld device, or any other device able to process data configured to execute one or more software programs configured to perform one or more functions, a device including a processing device (e.g., a processor), a computer-readable medium, and a memory. In some embodiments, the user device may be executing a browser application or other application adapted to communicate over Internet related protocols (e.g., TCP/IP and HTTP) and/or display a user interface.

In an embodiment, the dating network icon system may include a client operating on the user devices which is configured to communicate with a server to perform the functionality described in detail in connection with the Figures of the present application. For example, the icon-based dating network system may be implemented by having a client application on a mobile device associated with the user, wherein the client application is configured to communicate with one or more remote computers (e.g., one or more servers) via a network.

In an embodiment, the dating network icon system includes and/or is associated with a database (herein the “icon database”) configured to store the multiple icon profiles and instructions associated with the processes performed by the dating network icon system. The icon database may include any computer readable storage medium. The term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media. Other alternate mobile efficient technology may be integrated and utilized in conjunction with the described invention to multitask, improve site navigation, purchases and search commands and the like, which may be voice activated and controlled by mobile applications.

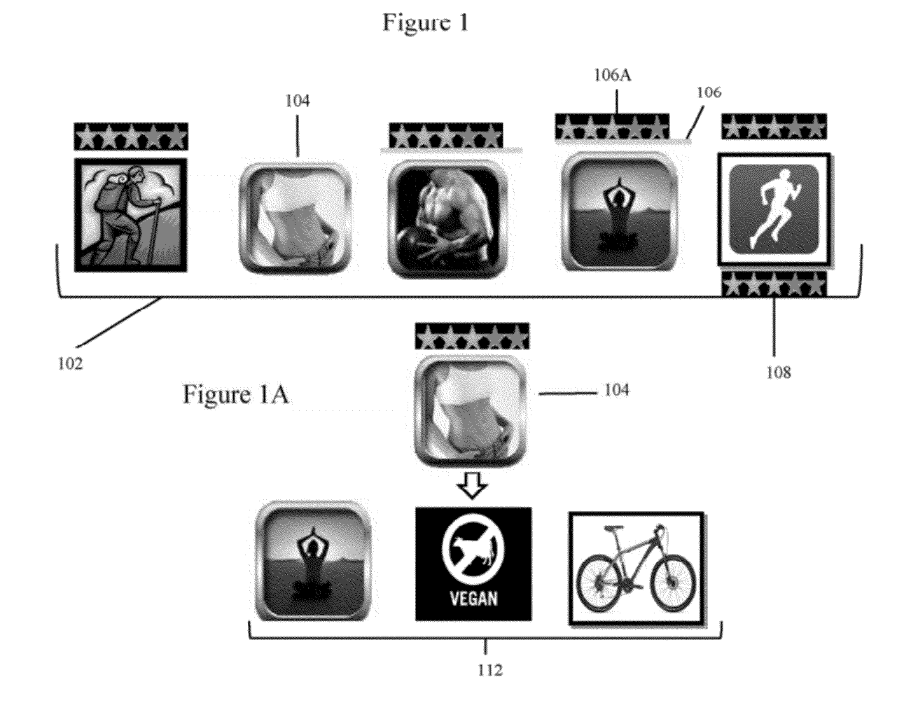

FIG. 1 illustrates an exemplary arrangement of associated icons maintained by the dating network icon system, according to embodiments of the present invention. In FIG. 1, an icon bank 102, or a collection of related icons is shown. The exemplary icons in the icon bank 102 provide examples of the vast communication properties of icons for use with the dating network icon system. As shown, the exemplary icons provide and communicate important and instant compatibility information relative to a dating profile element (e.g., a particular activity or interest), even without the use of associated text descriptors. Construction by the system, advertiser, user, group or use of the available icons may contain properties to distinguish subgroup preferences and differences linked to search terms.

The example icon bank 102 includes five icons relating to fitness. Each icon represents a different subcategory or sect having an established and instantly familiar meaning to those having an interest in the category associated with the icon bank 102 (in this case, fitness). For example, a generic or nondescript icon (e.g., the general fitness icon 104) may provide a less accurate assessment of compatibility and may cause a negative result for a joint activity while also increasing match results and potential contacts.

For example, a first user selecting icon 104 for inclusion in his/her single friendships and dating profile and a second user selecting icon 106 for inclusion in his/her dating profile have both indicated an association with fitness, however, they are not necessarily compatible since the first user indicated an interest in fitness generally 104, while the second user specified an interest in yoga 106.

As shown in FIG. 1, a user is able to indicate a skill or experience level associated with the icon, such as, for example, using the skill level indicator banner 106A associated with icon 106. The skill level associated with an icon represents a secondary descriptor which may be used by the dating network icon system in determining compatibility among users, dating groups, dating activities, dating associations, etc. For example, a first user indicating a skill level 106A associated with icon 106 may not be compatible with a second user indicating a higher skill level associated with the same icon 106.

In another example, a first user selecting a general fitness icon 104 and a second user selecting a yoga icon 108 may not necessarily practice the same type of fitness activities, however, the first user may wish to connect with the second user for other purposes, such as, for example, if the first user is interested in learning yoga. In this regard, users of the dating network icon system may make their own assessments of an acceptable match based on a consideration of the icons in another user's icon profile.

As shown in FIG. 1, another secondary descriptor that may be associated with an icon is a passion level indicator 108. A user may indicate his or her passion level associated with a dating profile element represented by an icon using, for example, the passion level indicator banner 108 shown in FIG. 1. The passion level may be used as a secondary descriptor and a further basis for identifying and determining matches among users and dating opportunities within the dating network icon system.

FIG. 1A illustrates an exemplary icon 104 representing a general characteristic, lifestyle choice or trait (e.g., general fitness) and a subcategory of related icons 112 indicating further specificity regarding the primary icon 104. In an example, a user may select icon 110 to indicate that the user is generally interested in fitness in order to generate more matches within the fitness and exercise communities (i.e., using the icon to over-include other fitness related icons). In an embodiment, the general icon 104 may be associated with the subcategory 112 of icons which further define particular dating profile elements related to the generic icon 104 that a user may include in his or her dating profile. In embodiments, creating a subcategory 112 may clarify, define or refine a user's preferences, traits, or capabilities, such as, for example, indicating that the user enjoys yoga, is a vegan, and is a bicycle rider; provides activity preferences and intensity, a link to other related media (e.g., videos, images), and/or provides a link to the user's blog and posting history relating to the dating profile element. In an embodiment, some or all of the secondary descriptor information may be used as one or more tags or keywords to be used in search and matching algorithms, described below in greater detail.

In embodiments of the present invention, a secondary descriptor indicator may be associated with any profile icon (e.g., 104) to indicate further information regarding a user's and or their preferred or required friend or dating candidate's relationship or specification, with an icon and its underlying dating profile element. For example, icon 104 may have associated therewith an indicator (not shown) such as a “G” for general interest, “F” for fan, “I” for instructor, “R” for requirement or other like secondary descriptor indicator.

As shown in FIGS. 1 and 1A, the dating network icon system is configured to provide richly detailed and/or layered animated icon-like images with revealing secondary descriptors and secondary or subcategory icons and associated information relating to a user or candidate dating profile element (e.g., a personality trait, dating preference, activity, interest, or other category) which communicates further details relating to the user's preferences and attributes. This body of information may be used by the dating network icon system to enable a user to more accurately and precisely select or identify other users, learn detailed preferences and requirements and find their preferred matches quickly, without searching a text profile. In embodiments, the icons and associated secondary descriptors may be considered in generating search results, matches, compatibility, groupings, and online forums.

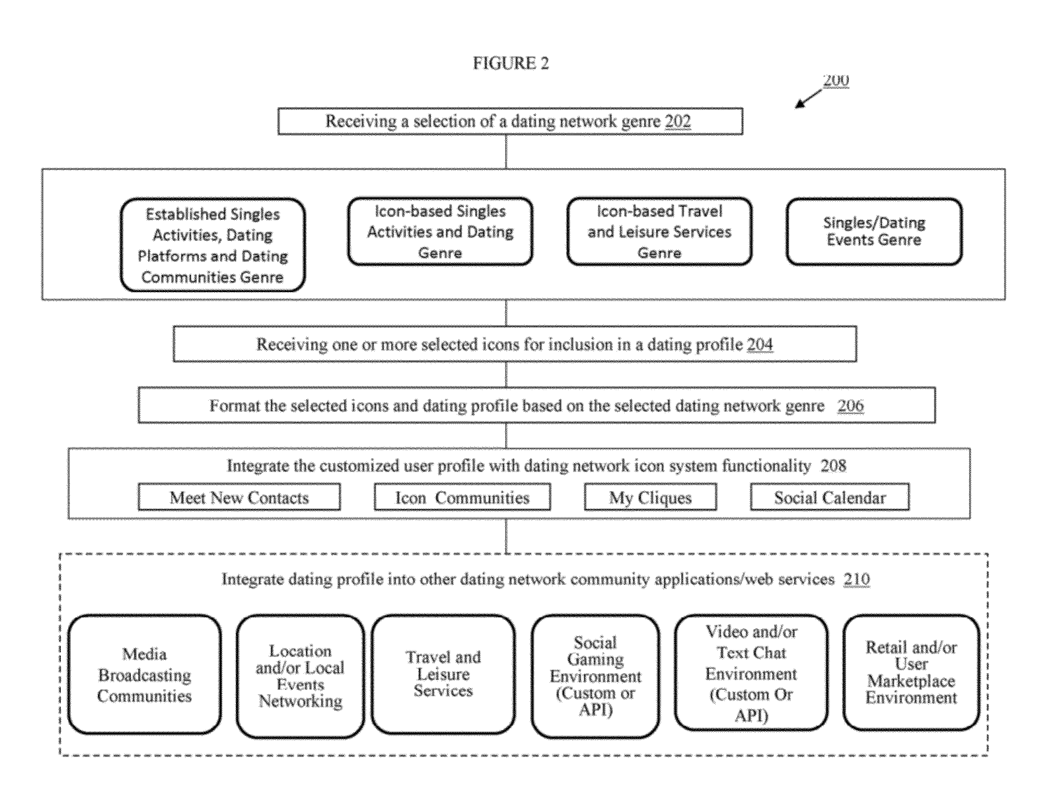

FIG. 2 illustrates a workflow illustrating an exemplary genre-based dating profile creation method 200, according to embodiments of the present invention. As shown in FIG. 2, in method 200, a user may interact with the dating network icon system in order to create a dating profile using a dating network genre provided by the dating network icon system. In block 202, a selection of a dating network genre is received by the dating network icon system. A dating network genre may be any primary community demographic classification, area or use associated with dating networking which may be used as a guide for the user in establishing a dating profile within the dating network icon system. In embodiments, the dating network genre type may provide a framework within which the user may create a dating profile, and have any number of setup screens or steps that are associated with, related to, or customized for a particular genre type. Exemplary dating genre types may include, but are not limited to, an established/external singles activities, dating platforms, dating communities genres, an icon-based singles activities and dating genre, couples dating groups, an icon-based travel and leisure services genre, and/or a singles/dating events genre (i.e., either established/external or icon system-based). One having ordinary skill in the art will appreciate that in addition to the examples described herein and shown in FIG. 2, other genre types may be employed in connection with embodiments of the present invention.

In embodiments of the present invention, based on the selection of the dating network genre received from a user in block 202, an appropriate portal (e.g., an application programming interface API or a set-up wizard) may be employed which guides the user through one or more steps relating to the creation of a dating profile. In an embodiment, the dating profile setup steps may be genre-specific such that the particular genre selected by the user informs the dating profile setup workflow (e.g., the types of information and manner of presentation of screens, fields, prompts, icons, pallets, etc. presented to the user during the dating profile creation process).

In block 204, the dating network icon system receives one or more selected icons for inclusion in the dating profile. In an embodiment, the icons may be selected by a user from a genre-specific pallet or library of icons. In block 206, the dating network icon system formats the selected icons and the dating profile based on the selected dating network genre. In an embodiment, based on the selected genre, particular formatting and/or customizing may be performed with respect to the icons and/or dating profile. For example, if a user selects the icon-based singles activities and dating genre, the associated dating profile may be formatted to include information relating to the user's activities, interest, preferred or favorite meeting places, etc. In an embodiment, in block 206, the dating network icon system may receive secondary descriptor information from the user to customize the selected icons included in the dating profile.

In block 208, the dating network icon system integrates the customized dating profile with one or more functional areas of the dating network icon system (i.e., the dating network icon system functionality) for use of the dating profile within the various functional areas. Exemplary categorical functional areas of the dating network icon system, shown in FIG. 2, include, but are not limited to, “meet new contacts” functionality, “icon communities” functionality, “my cliques” functionality, and/or “social calendar” functionality. It is noted that various additional areas of functionality are included with the dating network icon system, and that the examples shown in FIG. 2 are for illustration purposes.

Optionally, in block 210, the dating network icon system may integrate the customized dating profile with other environments including dating network community applications and/or web services. The optional nature of block 210 is represented in FIG. 2 by a dashed line. The other dating network community applications and/or web services may include dating network icon system-based and/or third party environments, applications, programs, and/or web services, such as, for example, third party travel websites/applications, third party dating networking websites/applications, third party retail websites/applications, etc. Exemplary functional areas of the dating network icon system, shown in FIG. 2, include, but are not limited to, media broadcasting communities, location and/or local events networking, travel and leisure services, social gaming (e.g., custom or API-based), video and/or text chat environments (e.g., custom or API-based), and/or retail and/or user-based marketplace environments.

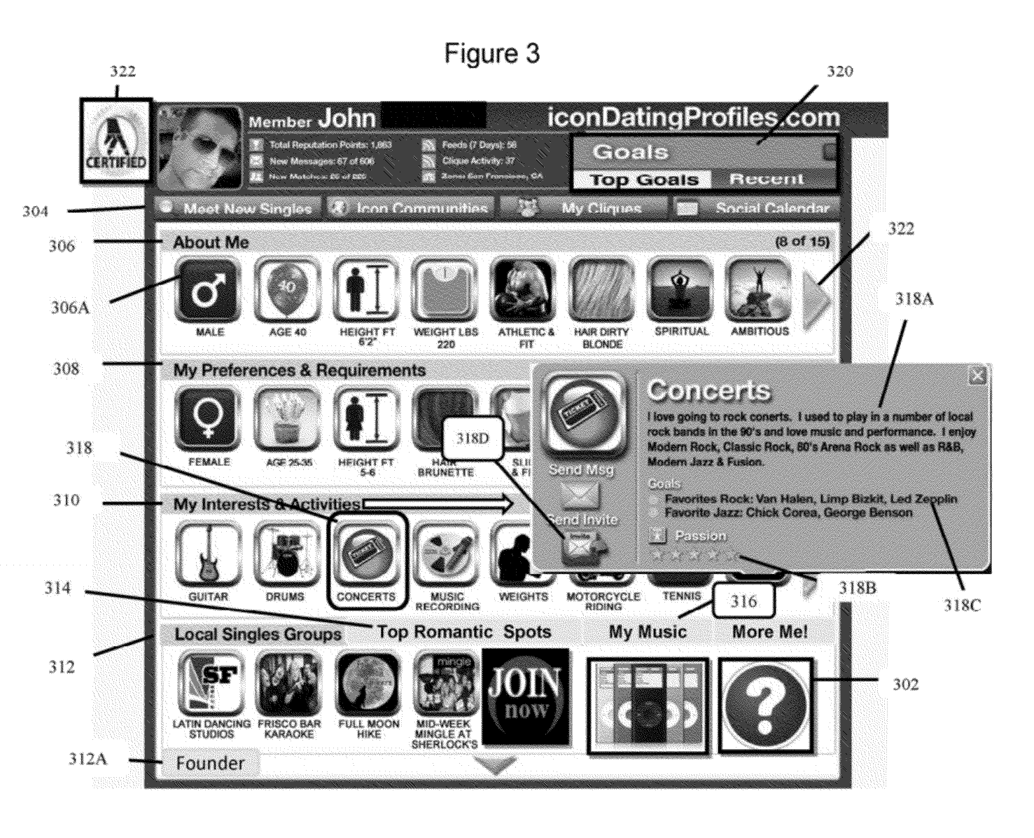

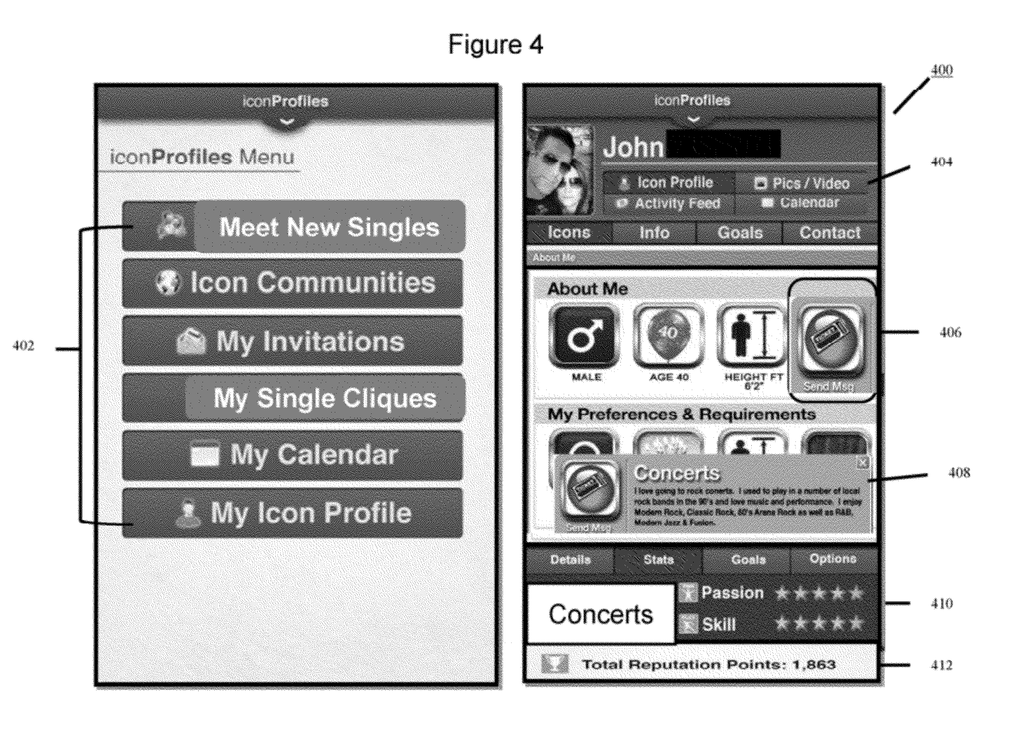

FIG. 3 illustrates exemplary interface of an icon-based dating network system displaying an icon-based dating profile 300 associated with a first user (i.e., “John”) including exemplary secondary descriptors, according to embodiments of the present invention. The exemplary dating profile 300 may be displayed via the dating network icon system on a mobile phone (as shown in FIG. 4), a mobile tablet or other computing device, according to embodiments of the present invention. Each icon of the dating profile 300 may be interacted with [e.g., touched in a touch-screen environment or interacted with a point device (e.g., a mouse and associated pointer)] in order to perform an action associated with the selected icon (e.g., obtain additional information about an icon).

As shown in FIG. 3, the dating profile 300 may include an image (e.g., an actual picture or avatar) identifying the user associated with the dating profile 300. It is to be appreciated that for privacy reasons, a user may elect to use an avatar instead of an actual photograph. In an embodiment, the user may create an avatar that resembles the user for their public dating profile. This privacy feature is useful when rejecting offers for friendship and encourages more users to set up profiles.

In yet another embodiment, the dating network icon system may be configured to only use avatar or no profile pictures in a public version of a dating profile (i.e., a version of the dating profile that is accessible by any user of the dating network icon system). In an embodiment, a private dating profile (i.e., a dating profile accessible only by other users who are connected or linked to the user) may include a user's actual profile picture and may be revealed with authorization after a connection is accepted or if a person is linked to a user's friend. This allows all users to experience match results with other dating profiles maintained in the icon database, but only reveal his or her identity (e.g., real name, contact information and/or picture) to other users that he or she accepts or connects with. In an embodiment, a user may request participation of another person in the dating network icon system by sending email invitations from their email contacts or friend lists and related data from other sites. In an embodiment, a user's imported friends may be categorized in contact or icon activity groups (e.g., one or more “Icon Communities” or “My Cliques” shown in FIG. 3) and icon compatibility may be determined and reported. In an embodiment, imported contacts may be automatically linked to a priority position in the user's search results and/or other displays in the dating network icon system. In some cases, users may discover new interests of their current friends and realize an ‘actual’ romantic compatibility ranking with those friends using the dating network icon system. Active users may also receive priority, community recognition, status and perks compared to less active users of the site.

In an embodiment, a user may also determine compatibility and shared traits with a larger community or zone based on elements in their dating profile. These compatibility trends or comparison results may be posted to the members of a given community (e.g., a geographic community or an icon-based community). Under certain settings, when a user has accepted another user for an activity, users may share typical narrative personality profiles whereby the other user is able to learn more about their new potential dating match prior to an initial meeting. In an embodiment, a privacy setting may be controlled by the user with respect to any data and/or icons in the user's profile to enable the user to control which information/icons are displayed publicly (i.e., as part of the user's public profile).

In an embodiment, some information and preferences may be utilized by the dating network icon system to determine compatibility without explicitly stating or presenting every realized compatibility element. Some information, icons and data may be viewed by the user in an inactive page or folder. Further such information may be selected to be hidden from public view but still utilized for certain system functions such as in determining compatibility and search results. This data may be displayed and used in the dating network icon system based on the user's preference requirements. In an embodiment, a narrative may be composed by the user or partially derived from a personality profile test administered by the system, by usage, or icon profile data, and may be accessed via an icon such as the “More Me!” icon 302. Alternately, this icon link may reveal an addition icon page containing less important icons.

For example, a text description associated with a user named Rich may include “Rich is single, works in the legal field, likes all outdoor activities and is very competitive and athletic. He is a straight shooter and honest. Rich's 5 favorite activities are: clothes shopping, attending rock concerts, playing basketball, playing guitar, and running. He is typically free on Tuesday evenings after 7 PM PST. Check out his social calendar openings and join or invite him to a get together.”

As shown in FIG. 3, the dating profile 300 is integrated with various features, functionality and environments 304 (e.g. a “Meet New Singles” environment, an “Icon Communities” environment, a “My Cliques” environment, and a “Social Calendar” environment). A user may access these environments 304 from his or her dating profile, and use his or her dating profile in those respective environments 304.

As shown in FIG. 3, the dating profile 300 may include multiple icon categories or groups, such as, for example, the “About Me” icon category 306, the “My Preferences & Requirements” icon category 308, the “My Interests & Activities” icon category 310, the “Local Singles Groups” icon category 312, the “Top Romantic Spots” icon category 314, and the “My Music” category 316. It is noted that the dating profile may include any number of icon categories, and each icon category may include any number of icons as desired by the user creating the dating profile.

In an embodiment, the “About Me” icon category may open an additional profile which may include icons representing personal characteristics, personality traits, likes, dislikes, things, candidate preferences, and/or physical attributes, such as, for example, a gender 306A, age, height, weight, religious belief, etc.

As shown in FIG. 3, the dating profile 300 may also include an exemplary icon section, additional profile page or grouping relating to the user's preferences and/or requirements relating to the user's desired partner, single friend and/or potential dating match (e.g., the “My Preferences & Requirements” section 308).

The dating profile 300 may also include an exemplary icon section or grouping relating to the user's interests, activities, hobbies, etc. (e.g., the “My Interests & Activities” section 310). In an embodiment, the dating profile 300 may include an exemplary icon section or grouping including an icon associated with the user's music, movies, book, entertainment, etc. preferences (e.g., the “My Music” group 316 shown in FIG. 3)

In an embodiment, the dating profile 300 may include an exemplary icon section or grouping (e.g., the “Local Singles Group” section 312) including icons associated with one or more singles groups, hang outs, which may be associated with a concierge service or advertiser with which the user is affiliated. In an embodiment, a user's status as a “founder” 312A of a local singles group may be displayed in the dating profile. According to an embodiment of the present invention, a founder of a new subgroup has the ability to control and administer some of the information, icon pop up information, group purpose and mantra, number and sex of members, media, news, advertising and posts for that group or control all sub group or local chapter formations.

In an embodiment, the dating profile 300 may include an exemplary icon section or grouping (e.g., the “Top Romantic Spots” section 314) including one or more icons associated with one or more locations where the user typically likes to go on dates. In an embodiment, the “Top Romantic Spots” icon category 314 may be linked to an advertiser with reservations or purchasing functions, invitations, a map and/or icon social calendar in order to quickly arrange a date or a group activity.

In an embodiment, a user may store and prioritize favorite location icons for frequent activity meeting places. The structure and look of icon profiles, categories and icons may be customized by the user. In another embodiment, an integrated, pictorial collage-like image profile is used as a profile page.

In an embodiment, a “My Store” icon category (not shown) may be provided in the dating profile and provide a portal to an environment wherein the user may offer to sell, buy, recycle or promote personal items and services (potentially for a fee) which may be viewed on the dating profile page or in a related icon community feed tagged within a user's selected zone. In an embodiment, seller ratings may be provided along with online payment or bidding systems. In an embodiment, users may benefit from having access to a dedicated icon online marketplace to buy and sell items and services relating to specific dating profile elements (i.e., particular passions, activities, and interests). These icon aggregated communities of experts and enthusiasts provide a specialized and optimized buying and selling market.

In an embodiment, the secondary descriptor information for an icon and/or icon group may include a measure of the level of the user's participation, rating options, and status in that group as well as other tools such as a full group view or join feature and further information.

In an embodiment, the dating profile 300 may also include a section relating to one or more goals 320 established by the user. Under a “goals” category 320, a user may display his or her goals, ideal dates, activities, ambitions, ideal preferences or aspirations relating to dating, romance, and relationships which he or she has not yet realized. An indicator may be configured to differentiate the icon as a goal, thereby indicating that the user has not attempted or experienced that activity or is a novice. The “goals” category 320 may also attract other users who have the same ambition, attract a mentor, or allow users of a concierge service (described below) or advertisers to find users or groups who may want specific instruction, activities, events, offers, news, information or services to help them reach an icon displayed goal. A user goal status feed and status summary may also be displayed allowing another user quicker access to all or a portion of a user's posted goals from their profile. In an embodiment, users may be matched and search based on their goals associated with an icon.

In embodiments of the present invention, any of the icons in the dating profile 300 may be interacted with or selected by the users of the dating network icon system in order input and/or review additional information associated with the selected icon (i.e., the secondary descriptors). For example, as shown in FIG. 3, dating profile includes a concerts icon included in the “My Interests & Activities” section of the dating profile 300.

By interacting with the concerts icon 318, a pop up window 318 is generated and allows the viewer to review secondary descriptors set by the user which are associated with the concerts icon. For example, the concerts icon and associated pop up window 318 may communicate multiple secondary descriptors including, for example, a text-based description 318A, a passion level indication 318B, and a goals indication 318C. In an embodiment, the pop up window also allows other users to contact the user to inquire about engaging in that icon activity with the user, using, for example, the “send invite” icon 318D.

In an embodiment, any of the secondary descriptors may also be displayed in connection with the icon as it appears on the main dating profile display. For example, the guitar icon may be associated with level indicator like 318B (e.g., a passion level or skill level indicator) which is visible from the main dating profile display, without requiring a pop up window to display the secondary descriptor information.

In an embodiment, secondary descriptors that may be associated with an icon genre, type or advertiser icon, may include, for example, a voice recording, animation, music file, text box, link, badge, ranking, a preference, a requirement, a rating or video. In an embodiment, the pop up window 318 may appear above an associated icon, or an animation may appear (e.g., an animation wherein the icon appears to flip over), or in a text box on the screen with a user's desired action or more descriptive icons appearing along with an actionable pallet of user contacting methods or other suitable tools. In an embodiment, the viewer may control what level of detailed information he or she wishes to view by selecting a user's icons.

In an embodiment, the user's customized selection of icons for inclusion in his or her dating profile and any associated secondary descriptors may be associated with an icon search term for use in determining a user's desired specificity for compatibility. For example, a less specific icon within a category may result in a broader compatibility outcome (e.g., results in a greater number of matches) as compared to a highly specific icon.

The described additional skill, passion and/or preference detail may remain “covered” unless the viewer touches or otherwise interacts with a top-level icon. In an embodiment, presenting the secondary descriptor information in a convenient manner dramatically shortens the time a user spends evaluating a dating and preference profile and determining compatibility. For example, a user may request to view matches, candidate preferences only, or only show results based on certain key secondary descriptors (i.e., use the secondary descriptors as a filter). The resulting sorting or consolidation process may be user-driven or performed by the dating network icon system in order to provide consistent profiles for all users and device types.

In an embodiment, a user may post icon-related pictures, images or videos regarding a specific icon or group, under a main icon to provide more specific information. For example, a user may display a “Sleepless in Seattle” icon as a favorite movie on their dating profile. Highlighting that icon may display the user's favorite clip or scenes from that movie or a presentation of the “Sleepless in Seattle” movie may be embedded by and presented by the paid system icon advertiser, while view count and other statistics are monitored by the system. Further examples include a community group icon for “Sleepless in Seattle” memorabilia buying and selling. One having ordinary skill in the art will appreciate that additional embodiments may be employed for stacking, embedding, sharing, tracking, linking and displaying secondary descriptor information.

In an embodiment, the dating profile 300 may be certified, as indicated by the “certified” designation 322 (which may be shown in a main header area or in connection with a specific icon, such as, via a pop-up window associated with the icon). A user and his or her associated dating profile may be certified or ranked by other users to demonstrate that the dating profile is authentic and represents the underlying user and their peer activity rating with which the profile is associated by any suitable method known in the art (e.g., via an algorithm check of independent information used to authenticate the identity of a user, by charging a fee to obtain certified status, etc.)

According to embodiments of the present invention, the dating profile (e.g., dating profile 300 in FIG. 3) may be used by the dating network icon system to determine compatibility of the user associated with the dating profile 300 with other dating profiles maintained by the dating network icon system. In embodiments, many traditional and interpretive methods of compatibility, association, and preference may be selected by a user or the dating network icon system's matching algorithms. Embodiments of the present invention include, but are not limited to, preset lists of various match algorithms including interpretations, theories, associations, random or other derived assumptions of compatibility compared to direct icon compatibility such as having a matching Icon and skill level requirement. In addition, matching criteria may be derived from the community practices or based on norms within that community. A dating network icon system-selected or user-selectable compatibility option wheel or list may be offered that contains traditional and less traditional profile matching customized for the dating community, such as, for example, personality traits, physical attributes, dating preferences, social standing, tests, games, lifestyle, psychology, ideology, hobby and interest personality traits, opposites pairing such as matching a “creative” icon with a “pragmatic” icon, team compatibility, interest category hierarchy matching, entertainment, fantasy, games and other measures based off usage, and or icon or use profile selections.

According to an embodiment of the present invention, the passion level indicator (e.g., 318C in FIG. 3) is displayed in order to allow viewers further clarity on compatibly based on their unique preference. For example, two users with a large variance in passion relating to a particular dating profile element may not be interested in each other despite having a common icon in their respective dating profiles.

In an embodiment, the icons included in a dating profile may be categorized or marked as an “active” or a “past” interest, position, profession, or association. A past interest or inactive indicator may infer the person's skills are probably lacking or they are not very interested in participating in that area. This information may be used to increase compatibility with another user if the interaction is based on an activity. Frequency indicators (e.g., how often or frequently a user participates in an activity) may also be provided in the first level (e.g., a top level or initial display of a dating profile) of an icon or dating profile view or a second level of the icon or dating profile view (e.g., following an interaction with the top-level icon). For example, an expansion of an icon associated with an activity may include second descriptors such as a next available date or typical date preference for participating in the activity.

In an embodiment, a passion level indicator may also be associated with an icon as a user may be passionate, but lack skill or experience. In operation, after selecting an icon for inclusion in the dating profile, a user may select a status identifier such as a “Fan” or “Participant” in place of a skill rating, and also provide an indication of a passion or skill level. In an example, a “Beginner” or “Novice” indicator may be associated with the icon to differentiate it from a user who is an expert or highly skilled in the underlying dating profile element. In embodiments, students or beginners may be invited to events and enjoy the icon group community and news feeds configured for that audience, such as, for example, classes or tutorials. In an embodiment, users may search profiles based on their preference for a certain skill, intensity preference or passion level for an activity, or area which may be communicated via an icon and a secondary descriptor.

According to embodiments of the present invention, an icon-based dating profile allows for a more abstract, conceptual, and high level presentation of a person's interests, skills, experience and personality. Unlike the substantial limitations of a text based singles' profile, the icon-based profile's image quality, selection, content, organization and secondary information provides insight into a user to assist in an evaluation of the user's potential compatibility.

According to embodiments of the present invention, various personality surveys, games and tests may be administered in connection with the dating network icon system resulting in icon pallet or activity result suggestions and/or associated certifications.

In another embodiment, a user's profile elements, either individually, grouped or in combinations are compared to other users profile elements to determine a significant repeated occurrence of associations between icon profile elements, whereby the system may determine and suggest these other related or “missing” system icon element activities, hobbies, interests, and the like. The icon element suggestions may be search or posted and based on common user icon profile element trends and associations and other associative element preference theories. In a basic exemplary process example, four users are determined to have 8 common icon elements collectively; user five has 5 of these common icon elements. The system stores and posts a recommendation of the 3 missing new icon elements to use five.

FIG. 4 illustrates exemplary interfaces of a mobile device application of the dating network icon system, according to embodiments of the present invention. As shown in FIG. 4, an exemplary dating profile 400 may be customized for a smaller display on a mobile device including basic dating network icon system functionality 402 and a toolbar 404 for video chat, media sharing and the like. As previously discussed, the icon categories 406 offer an easy-to-read, informative, and actionable profile overview with efficient attribute viewing capabilities compared to current lengthy and static text-based profiles and preference information for any social group genre.

According to embodiments of the present invention, the dating network icon system enables users to identify dating prospects and their candidate preferences efficiently by a current local zone, while also providing national or international opportunities.

In an embodiment, as shown in FIG. 4, the exemplary dating profile screen 400 includes a concerts icon 414 which is actionable to display second descriptors associated with the icon 406. In this example, a secondary descriptor including a text-based description 408 relating to the user's concerts icon 406 is displayed via a pop-up window. In addition, various statistics and preferences associated with the concerts icon 414 may be displayed, including a passion level indication and a skill level indication 410 and a “total reputation points” score 412 (e.g., a statistical assessment of the user's peer ratings and reputation, experience, passion or expertise level relative to a dating profile element which may be calculated and/or determined based on various information collected and maintained by the dating network icon system).

For example, using a touch screen device and a mobile application associated with the dating network icon system, the user may gesture swipe in the area of 406 to view additional icons in that category. According to an embodiment of the present invention, the first page or first icons are chosen as the most important to the user, or have been most utilized as determined by the system as the most skilled or passionate interests or candidate preferences. Other icon profile lists or pages may be created, managed and customized by a user for participation via API's or the like with different sites and communities.

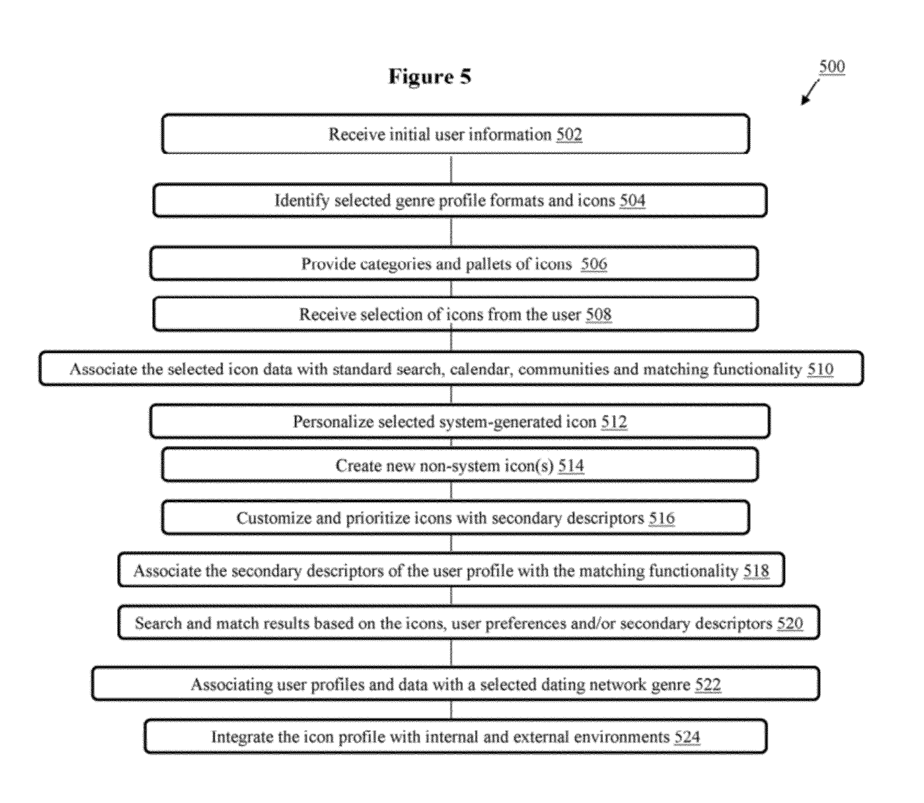

FIG. 5 illustrates an exemplary method 500 for generating an icon-based dating profile, according to embodiments of the present invention. As shown in FIG. 5, method 500 includes receiving initial user information from a user, in block 502. The initial user information may include, but is not limited to, basic background information of the user (e.g., sign-up information such as a name, address, etc.), an indication of a dating network genre (e.g., the genres described in connection with FIG. 2), and/or a selection of an icon profile creator system or functionality.

In block 504, the dating network icon system identifies the dating profile format and library or of icons associated with the selected genre identified in block 502 (or a general format and library if no genre is selected/specified by the user). From the identified library of icons, a pallet of icons including icon categories is presented to the user, in block 506.

In block 508, the singles and dating network icon system receives from the user a selection of multiple icons from the pallet of icons for inclusion in the dating profile. In an embodiment, the user may also be provided with an optional test or survey questions that may be used by the dating network icon system to generate icon suggestions or suggestions regarding prioritization of selected icons for the user.

In block 510, the dating network icon system associates, links, connects, relates, etc. the dating profile and optional candidate preferences including the icon data with one or more functional areas or environments of the dating network icon system which are configured to use the dating profile. For example, the one or more functional areas or environments may include, but are not limited to, the dating network icon system's searching functionality, social calendar functionality, community categories and groups, and the compatibility/matching functionality.

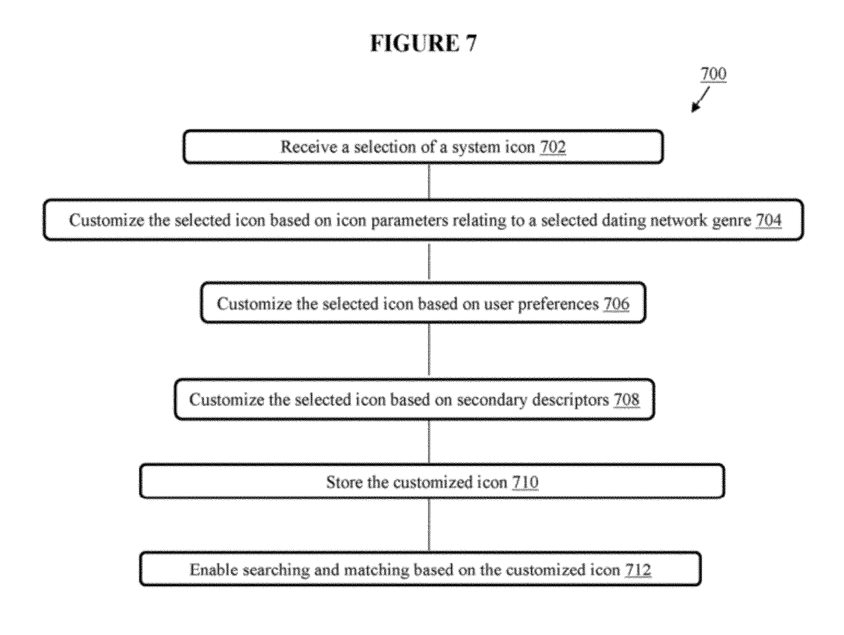

In an embodiment, in optional block 512, the dating network icon system may customize and/or personalize a system-generated icon based on user preferences, information and/or parameters received from the user, as described in greater detail in connection with FIG. 7. For example, the user may personalize the appearance of an icon according to his or her preferences. In block 512, the dating network icon system may customize an icon or dating profile in accordance with user-established preferences, such as, for example, privacy preferences, matching preferences, community preferences, social calendar preferences, etc. In addition, the dating network icon system formats the dating profile and/or icons included in the dating profile in accordance with the user preferences.

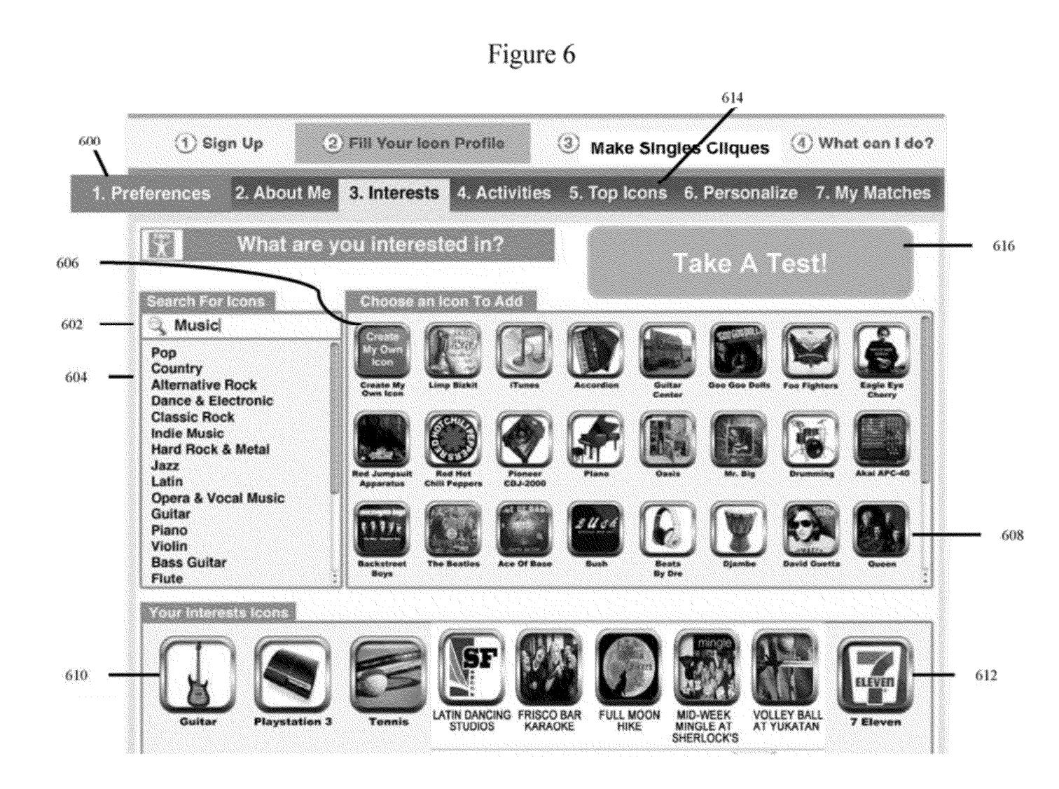

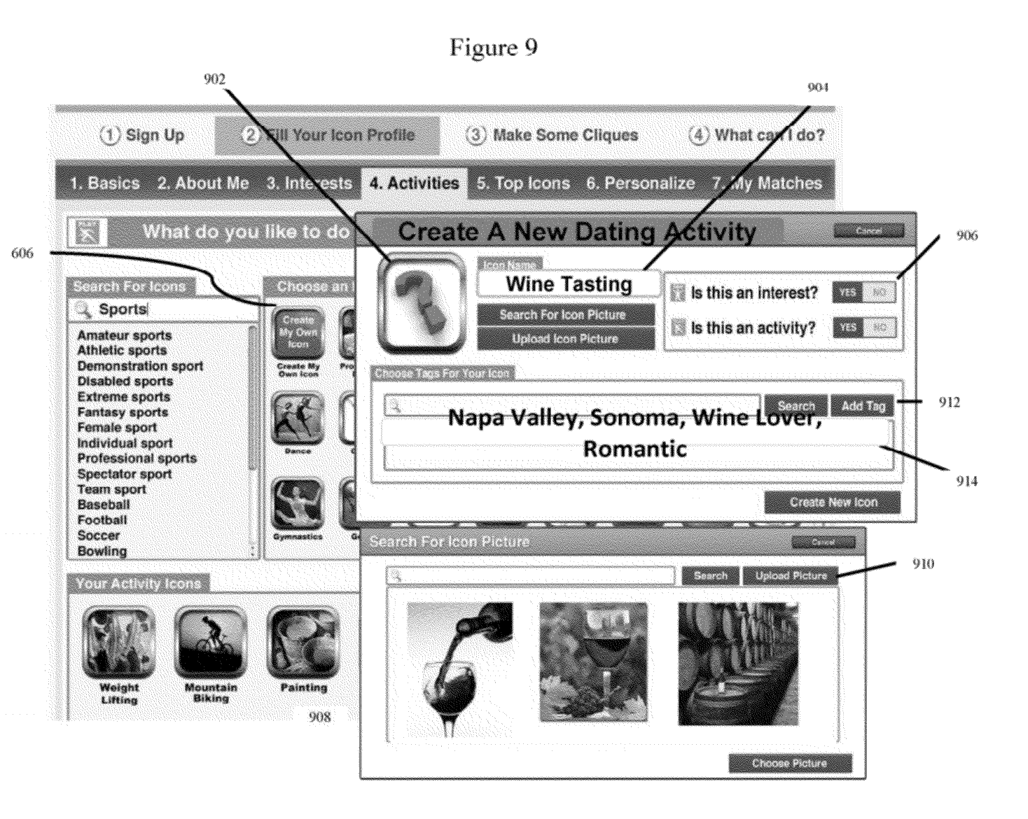

In an embodiment, in optional block 514, the dating network icon system may create a new non-system icon type (i.e., an icon not included in the initial library maintained by the dating network icon system) based on information, preferences, and parameters received from the user, as described in greater detail below with respect to FIGS. 6 and 9.

In an embodiment, in block 516, the dating network icon system customizes and prioritizes one or more of the selected icons in the dating profile with secondary descriptors, as described in greater detail in connection with FIG. 7. According to this embodiment, in block 518, the secondary descriptor information associated with the dating profile is stored and may be used in connection with the compatibility/matching functionality of the dating network icon system and other described system functions.

As shown in block 520, the dating network icon system is configured to search a database of dating profiles and match a first dating profile with other dating profiles based on the icons of the first dating profile, optional candidate preferences, user preferences, and/or secondary descriptors associated with the dating profile.

In block 522, based on a user selection of one or more genres in block 502 or a later selection of a dating network genre by the user, the dating profile and associated data may be added to the selected dating network genre system(s) for use therein.

In optional block 524, the dating profile may be distributed or exported to an internal environment (i.e., an environment or subsystem of the dating network icon system) or an external environment (i.e., an environment that is not maintained by the dating network icon system) for integration with a third party application or web services or for use in inviting other potential users to use the dating network icon system.

FIG. 6 illustrates an exemplary interface of an icon-based social network system displaying an icon profile creation tool configured to perform the method 500 shown in FIG. 5, according to embodiments of the present invention. In an embodiment, after signing up by providing basic user data, account preferences and uploading a photo or video, the user is prompted to select icons based on the category headers 600 (e.g., icon categories such as “preferences”, “about me”, “interests”, “activities”) and icons provided by icon system. In the example shown in FIG. 6, the user selects an interest in music 602 and one of the genres listed in associated music genre list 604 is highlighted. A pallet of icons, possibly from an advertiser are embedded with secondary media, linked to search terms, keywords, and other tag matching data is presented to the user in display area 608.

If, for example, the user selects the band “Queen” icon from the pallet 608, the Queen icon may appear in the “Your Interest Icons” display area and become part of the user profile along with any/all previously selected icons (e.g., icons 610 and 612).

As shown, the pallet of icons in display area 608 includes a “Create My Own Icon” icon 606 that may be used to create a new music-related icon, possibly matching the icon element secondary features and structure associated with this genre that is not found in the system-generated list. If the user wishes to create an icon, he or she selects the “Create My Own Icon” icon 606 and open a new icon creator or group icon creator system, shown in FIG. 9.

As illustrated in FIG. 9, in association with the “Create My Own Icon” icon 606, a pop up window 902 is displayed which allows the user to define a new user-generated icon. In an embodiment, the user may define parameters associated with the user-generated icon, such as an icon name 904, an icon type 906 (e.g., an activity and/or interest category and structure), and/or search for or select an image or representation for the icon. In an embodiment, upon selection of the icon picture search button, a pop up window may appear which includes a pallet of existing images that may be used for the icon or enable a user to upload a different image 910 from various internal or external media devices, image databases, editing programs, search sources and other related resources. In an embodiment, the user may use an “add tag” button 912 to add tags and/or keywords 914 associated with the icon.

In an embodiment, a user may routinely and dynamically change his or her profile icons based on their past activity schedule, seasonality, evolving preferences, location, and changing lifestyle. Notifications of these icon profile changes or status changes may be pushed to friends or into the general icon news feed. Friends in this system may also be automatically categorized, matched or organized based on usage or communication frequency. For example, top activity or compatibility matches and friends may be ranked for each icon, online community or group. Status updates or communications from those users may have high priority in the feed. For example, a match or friend statistics view may provide a list of friends for an activity, organized by an indicator presenting how many times they accepted an invitation for that icon activity.

Returning to FIG. 6, in an embodiment, once the user has selected all of the interest and activity icons the user may rank and/or order their interests based on their preference using the “Top Icon” button 614 and related functionality of the icon system. In an embodiment, the user may establish the icon priority by dragging his or her selected icons and placing them in a desired order. It is to be appreciated that the user may easily edit his or her user profile including the icon rankings as their ranking and/or other preferences change.

In an embodiment, the dating network icon system profile creator tool may include a surveying tool (e.g., represented by an actionable “Take a Test!” link 616) which provides a user with a test used to assist the user in identifying one or more icons for inclusion in the dating profile. In an embodiment, the test results may be stored in the user's dating profile and may be used by the dating network icon system for compatibility and matching purposes and/or displayed to other users.

FIG. 7 illustrates exemplary method 700 relating to generating a customized icon-based dating profile, according to embodiments of the present invention. One having ordinary skill in the art will appreciate that the blocks shown in FIG. 7 represent optional parameters, preferences, and/or information that may be received from the user and/or determined by the dating network icon system for use in customizing one or more icons and/or a dating profile.

In block 702, a selection of an icon is received by the dating network icon system. The selected icon may be associated with icon information including, but not limited to, icon header display text, an icon identification number, a media element (e.g., an image or video), an indication of other associated icons, and one or more searching and/or matching terms, tags, and/or keywords.

In block 704, if a dating network genre has been selected, the dating network icon system identifies any icon parameters (e.g., features, structure, format, requirements, etc.) for the selected icon based on the selected dating network genre. The dating network icon system then customizes the selected icon based on the genre-related icon parameters.

In block 706, the dating network icon system receives user preferences provided by the user relating to customization of the icons for the dating profile. Exemplary user preferences associated with individual icons and/or the dating profile may include, but are not limited to, selecting a display preference when an icon is touched or selected, setting matching preferences including whether the user allows matching invitations, adding associated gear and/or gear preferences, automatic user-to-user matching, profile privacy settings (e.g., identifying portions of a dating profile for inclusion in a public profile and/or a private profile), preferences relating to the sharing of icon updates, and setting preferences with respect to concierge services and/or advertisements. It is to be appreciated that additional user preferences may be utilize to custom icons and/or dating profiles in the dating network icon system. One having ordinary skill in the art will appreciate that in certain instances, block 706 is optional, in that a user may not identify any user preferences for use in customizing the selected icon.

In block 708, the dating network icon system receives one or more secondary descriptors associated with the selected icon. Exemplary secondary descriptors associated with individual icons and/or the dating profile may include, but are not limited to, a selection of a dating profile element type (e.g., a “fan”, “participant”, etc.), a selection of a level indicator (e.g., a passion level indicator, a skill level indicator, etc.), a “quick view” symbol or indicator for inclusion on a top level dating profile page or display, a text-based icon description, one or more goals or aspirations associated with the selected icon and whether those goals are displayed in a goals feed, adding a social calendar association to the selected icon, indicating a frequency preference (e.g., active participant, former participant, retired participant, etc.), associating gear, equipment, brands with the selected icon, associating additional content (e.g., videos, links, applications, pictures, historical data, etc.) with the selected icon, and adjusting the placement and priority of the selected icon in the dating profile.

In an embodiment, a secondary descriptor may be associated with an icon which indicates whether that icon should be used as part of the user's candidate preferences (e.g., a version of the dating profile particularly suited and/or customized for use as a candidate's resume). It is to be appreciated that additional secondary descriptors may be utilize to custom icons and/or dating profiles in the dating network icon system. One having ordinary skill in the art will appreciate that in certain instances, block 708 is optional, in that a user may not identify any user preferences for use in customizing the selected icon.

In block 710, the customized icon is stored in the icon database and the searching and matching functionality is enabled based on the customized icon (e.g., the customized icon may be used for searching and matching purposes), in block 712.

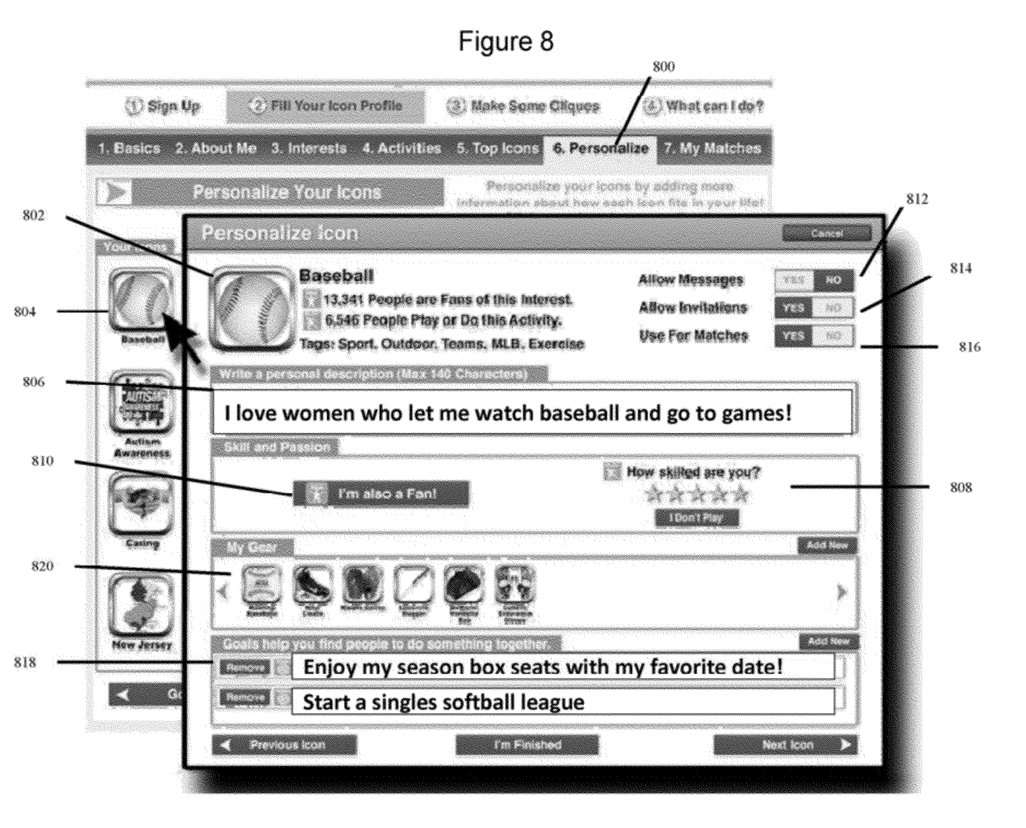

FIG. 8 illustrates an exemplary interface of an icon-based dating network system displaying a personalized icon including user preferences and secondary descriptors associated with the icon, according to embodiments of the present invention. In the example shown in FIG. 8, the personalized icon 802 may be generated according to exemplary method 700 which may be initiated by interacting with “Personalize” tab or button 800.

In an embodiment, the personalized icon includes user preferences and/or secondary descriptors, such as icon-related preferences, sub-icons (e.g., associated icons), goals, media, security preferences and further user or system customization. The user preferences and secondary descriptors allow the user to display further information in various forms in accordance with their own and or a dating candidate's preferences, dislikes and skills relating to a dating profile element which may appear as a pop up or other known or state-of-the-art displaying techniques when that icon is selected. This information is helpful to a viewer of a profile in determining a match or for learning more about a user's icon data box. This information is also utilized by the search engine for more precise matching, for community features and concierge and advertising services.

In this example, the user selects a baseball icon 804 for personalization from a group of the user's selected icons. In the icon header, the user may view the total approximate number of fans and players of the baseball icon within the dating network icon system. It is noted that this number may be filtered based on the selected zone and user compatibility matching. In the icon header, one or more tags may be shown which indicate other search terms related to baseball that is considered.

As shown in FIG. 8, the customized icon includes a text-based personal preference description 806. This text may appear as a pop up or second layer of information from a selected icon of interest. The customized icon may also include a skill and/or passion rating 808 and a related status 810 (e.g., the “I'm also a Fan!” status indicator).

In an embodiment, one or more user preferences associated with the selected icon may be set by the user, such as, for example, whether the user allows messages associated with the icon 812, whether the user allows invitations associated with the icon 814, and/or whether the personalized icon may be used by the dating network icon system for matching purposes 816.

In an embodiment, one or more user goals 818 related to the selected baseball icon may be set by the user, which, for example, may assist in more precise matching and with providing concierge and advertising services. In an embodiment, the icon-related goals may be shown in a goal summary feed or in an icon pop up. The icon-related goals may also allow the user to track progress of his or her achievements over time.

In an embodiment, the user may associate one or more favorite brands, gear, equipment, or the like (in the exemplary “My Gear” section 820) with the personalized icon. The “gear” information may be used as a means to provide, or push advertising data, and improve advertising results for the user.

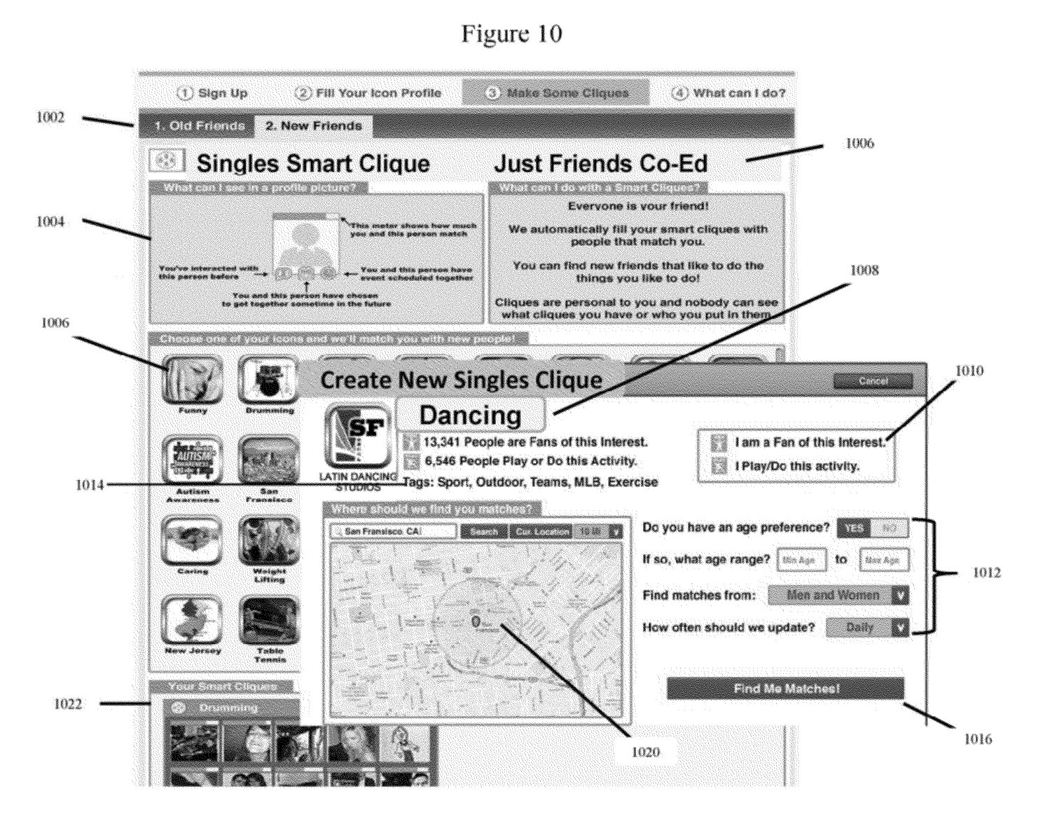

FIG. 10 illustrates an exemplary interface of an icon-based dating network system displaying an exemplary “smart clique” user group identifier and creator tool, according to embodiments of the present invention. As shown in FIG. 10, the dating network icon system is configured to perform “smart clique” matching and grouping. In the example shown, a user may initiate the clique generation process by interacting with the “New Friends” section 1002 within a “Make Some Cliques” tab, as shown in FIG. 10. In an embodiment, the dating network icon system may provide a searching tool 1004 which allows a user to indicate the one or more dating icons to be used to identify an existing dating-related clique or create a new dating clique.

In an embodiment, the user may elect to form a platonic or a ‘just friends’ singles clique that is not specifically tailored to identifying a dating or romantic connection. For example, the user may specify this setting by interacting with the “Just Friends Co-Ed” button or link 1006, shown in FIG. 10.

In an embodiment, the user may select one or more user, system or candidate icons and/or keywords for use in matching within a particular community. In this example, the user indicates that he or she wishes to identify or form a clique within the “dancing” icon community 1008.

In an embodiment, the user may select a status type 1010 (e.g., a fan, participant, etc.) that he or she wishes to use to identify potential clique matches. In an embodiment, the user may indicate searching filters, preferences and/or criteria 1012, such as, for example, an age range preference, a zone preference, a gender preference and an update frequency preference. In an embodiment, the user may create his or her own searching sort or filter. In the header of the icon, one or more tags and/or keywords 1014 associated with the dating profile element may be listed.

In an embodiment, the user may select a preferred geographic zone 1020 or location for the icon-based community. After results are posted, the user may save the search preferences and or individual members in their smart clique groups, such as the saved smart clique associated with a “drumming” icon community 1022. The cliques allow faster and more discrete communication for an icon activity or other grouping. In addition, cliques may also receive prioritized community interaction and communication with one another in the site. Upon completion of the fields associated with the clique creator tool, the user may cause execution of the tool by clicking on an actionable button or link, such as, for example, the “Find Me Matches!” button 1016.

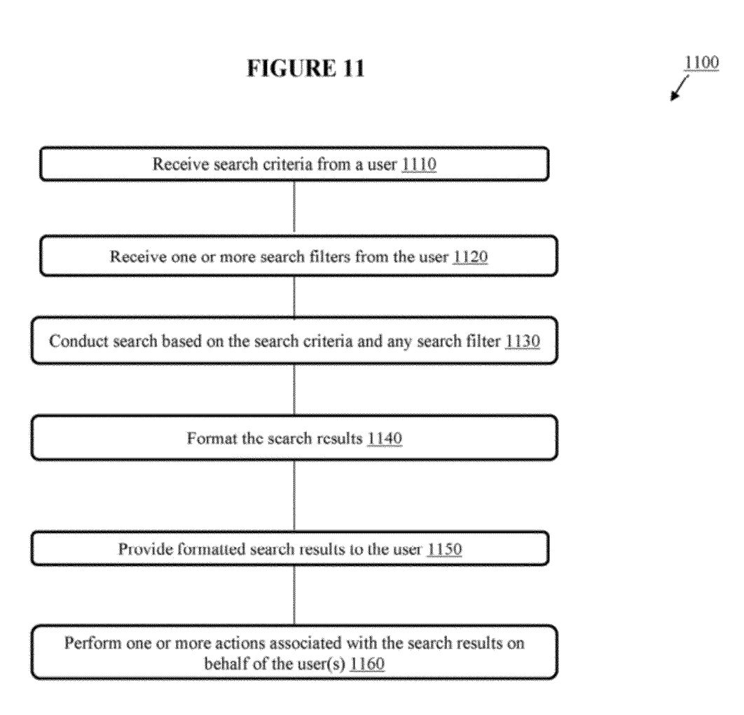

FIG. 11 illustrates an exemplary method 1100 for searching within the dating network icon system, according to embodiments of the present invention. As described above, the dating network icon system maintains multiple dating profiles and associated candidate preference icons in an icon database. Each of the dating profiles includes various information that may be used to identify the dating profile during a search, the information including, but not limited to, the user-selected icons, associated icon data (e.g., secondary descriptors), and user preferences. In an embodiment, the dating profile information is used to compare multiple dating profiles, identify potential employment opportunities, and/or compare the dating profiles with search criteria provided by or to the dating network icon system. Advantageously, according to embodiments of the present invention, the uniformity in the dating profile creation process, described above, optimizes the dating profile searching and compatibility accuracy.

These associated primary and secondary icons and text box descriptors may be associated with a search term, compatibility methods or terms for use with the search system. Viewing the associated search term, tags, key words, associations, or text descriptor when selecting an icon helps users select the icon that best describes each personality or icon group trait. A user may be allowed to add brief clarification text and/or secondary icons to further describe that interest or preferences within that interest. Other associated media and information may also be included and viewed by the searcher. These secondary user keywords may be used in search and matching algorithms. These icons may also provide a brief description of their meaning for other users viewing the icon, which may be displayed by pressing the icon or by a text descriptor below the icon which may also be the keyword search term.

In an embodiment, the matching system or searcher may utilize a higher or broader icon category topic, complimentary topic or interest in order to match more users and groups. For example, a dancing icon may have a search tag of “club dancing” “any style”. Users with any dancing style preference may potentially mutually enjoy “club dancing” together.

The exemplary search method 1100 is initiated by a user. In block 1110, the dating network icon system receives search criteria from the user. The search and matching criteria may be any information that may be used by the dating network icon system to identify other dating profiles, associated candidate requirements, including, but not limited to, one or more icons, one or more icon category/groups, one or more social calendar events, one or more keywords, one or more tags, one or more secondary descriptors, one or more user preferences, and any combination of multiple search criteria elements. In block 1110, the search criteria may be received from a user in multiple different ways, such as, for example, by conducting an icon-based search (e.g., a search of a community associated with a particular icon (i.e., an icon community), by conducting an social calendar-based search, by conducting a clique or group-based search, by conducting a candidate requirements search, by conducting a geographic or map-based search, and the like. For example, the user may conduct a search based on a baseball icon together with her preference for a certain skill or passion level for playing baseball an activity which may be displayed with its associated system icon.

In block 1120, the dating network icon system may receive one or more search filters or ranking sorts, referred to as “filters” from the user. The search filters may be used by the user to further specify, define, prioritize, organize, narrow, and/or focus a particular search. Exemplary search filters and rankings may include, but are not limited to, a smart-clique filter, additional search criteria, a “zone” or geographic limiter, an icon filter, a secondary descriptor filter, a user preference filter, a personality traits filter, a physical attributes filter, and the like. One having ordinary skill in the art will appreciate that in certain instances, block 1120 is optional, in that a user may not identify any search filters. It is noted that the user may customize and tailor a search using various combinations of search criteria and search filters to identify search results having a desired level of granularity or “ranked by” order.

In block 1130, the dating network icon system conducts a search of the icon database based on the search criteria and any applicable search filter(s) to identify a set of search results. In embodiments of the present invention, any suitable searching algorithm may be employed in order to identify one or more dating profiles matching the selected search criteria and applicable search filter(s).

In block 1140, the dating network icon system formats the search results in accordance with search result display parameters. In an embodiment, the search result display may be in any suitable format including, for example, a map-based view, a list-based view, a social calendar-based view, etc.), a report including compatibility results (e.g., dating profile compatibility scores, social calendar compatibility scores), a common or related icon list (e.g., a list of icons shared by the first user and the one or more dating profiles identified by the search), a ranked list of the dating profiles in the search results based on one or more of the compatibility results, a presentation of the search results including indicators identifying particular characteristics of the search results (e.g., an indicator identifying a common “high priority” icon match, a common status match, a “high/highest compatibility” match, a common friend/group/clique match), a comparison and possible ranked-order of secondary descriptors, etc.

In an embodiment, the user may select one or more preferred formats for the search results. Alternatively, if the user does not specify a preferred search result display parameter, the dating network icon system may use a default view or display format. In an embodiment, the dating profiles identified in the search and compatibly results may be scored and aggregated into a ranked icon-based result listing. In an embodiment, the dating network icon system may determine a compatibility score based on a combination of all of the search criteria elements entered by the first user (e.g., the searched icon(s), secondary descriptors, user preferences, etc.) to determine an overall compatibility score(s).

In block 1150, the formatted search results are provided to the first user. Following provisioning of the search results to the user, the dating network icon system may perform various actions associated with the search results based on instructions received from the user, in block 1160. In an embodiment, in block 1160, the first user may view a full dating profile of any of the dating profiles identified in the search results displaying highlights or other indicators of matching or compatible icon profile elements on the candidate's profile page (e.g., by touching or clicking on the desired dating profile). In block 1160, the dating network icon system may transmit a communication, (e.g., e-mail, chat request) or an invitation (e.g., an icon-based invitation, an event-specific invitation), a general connection request, a virtual gesture, (e.g., a request from a user to connect with another user), or an abbreviated profile, profile, or profile category from the user viewing the search results (i.e., the searcher) to one or more of the users identified in the search results. In addition, in block 1160, the dating network icon system is configured to perform actions on behalf of the one or more users (e.g., the searcher and the users identified in the search results) such as, for example, receiving the communication and the searcher, such as, for example, performing an instruction to accept or modify an invitation, add invitation data to the social calendars of the users, processing payment for any fee-based transaction (e.g., a concierge service), generating any reminders associated with an invitation, process any feedback associated with the communication, interaction, transaction between the users and add the feedback to the applicable dating profiles, etc., and executing a request from the searcher to add one or more users identified in the search results to a custom clique or confirm certain smart clique matches.

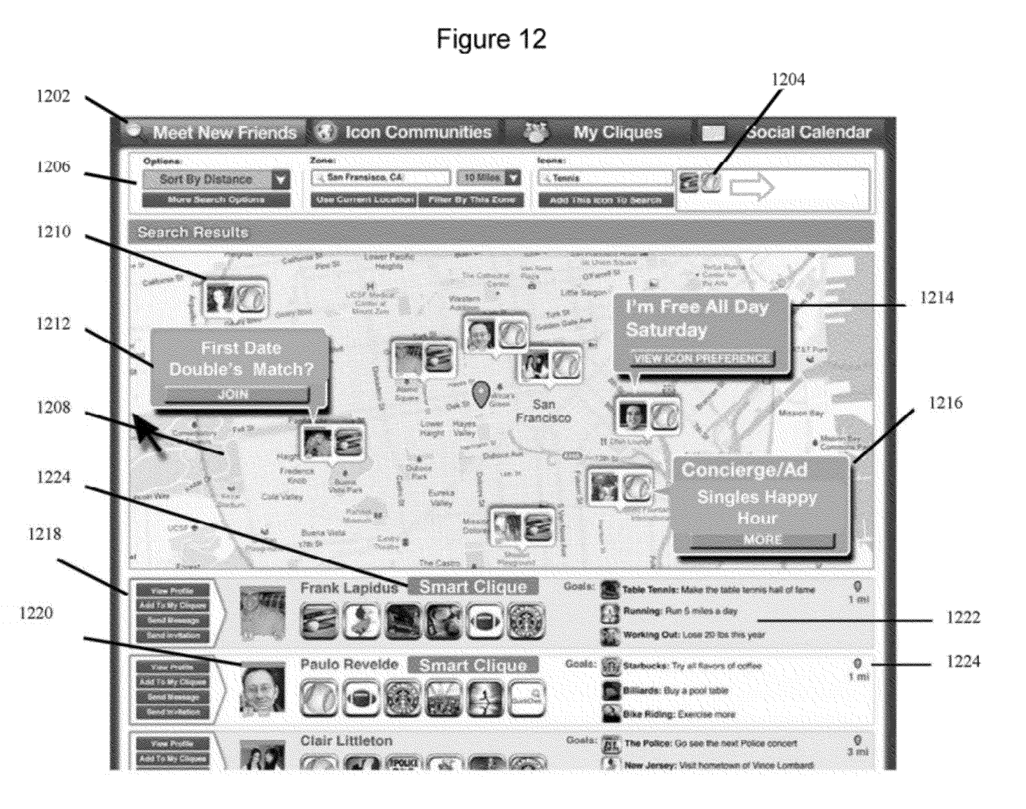

FIGS. 12-16 illustrate exemplary interfaces of the dating network icon system displaying exemplary search and compatibility results and associated user actions relating to the search results, according to embodiments of the present invention.

FIG. 12 illustrates an example of a map and list view search performed by the dating network icon system, according to embodiments of the present invention. In the example shown in FIG. 12, a user initiates a search in the “Meet New Friends” environment 1202 of the dating network icon system. The dating network icon system receives the search criteria including icons 1204 (e.g., a baseball icon and a tennis icon) and a search filter 1206 including a geographic or location limiter or shape-based zone (e.g., a ten mile zone centered on San Francisco, Calif.). In an embodiment, a user may prefer to only input their street name, and not their exact address number, which would in turn display a general area on a map result.

In the example shown in FIG. 12, the search results are formatted and displayed in a map format including a map 1208 displaying the zone specified in the search filter 1206. The search results include a number of dating profiles matching the search criteria, such as the single friend or dating profile/icon match 1210. In an embodiment, all or a portion of the dating profiles identified in the search results may be highlighted and/or displayed the map 1208. By selecting the highlighted icon, additional matching information and statistics may be provided.

In an embodiment, the user may click or otherwise interact with a user result to view an associated pop up display 1212. Exemplary information that may be primarily displayed by interacting with a match includes, but is not limited to, secondary information summaries, an invitation to join an event or group event 1212, an indication of a user's availability 1214, and an advertisement, concierge activity, promotion, or coupon 1216 associated with the search result.

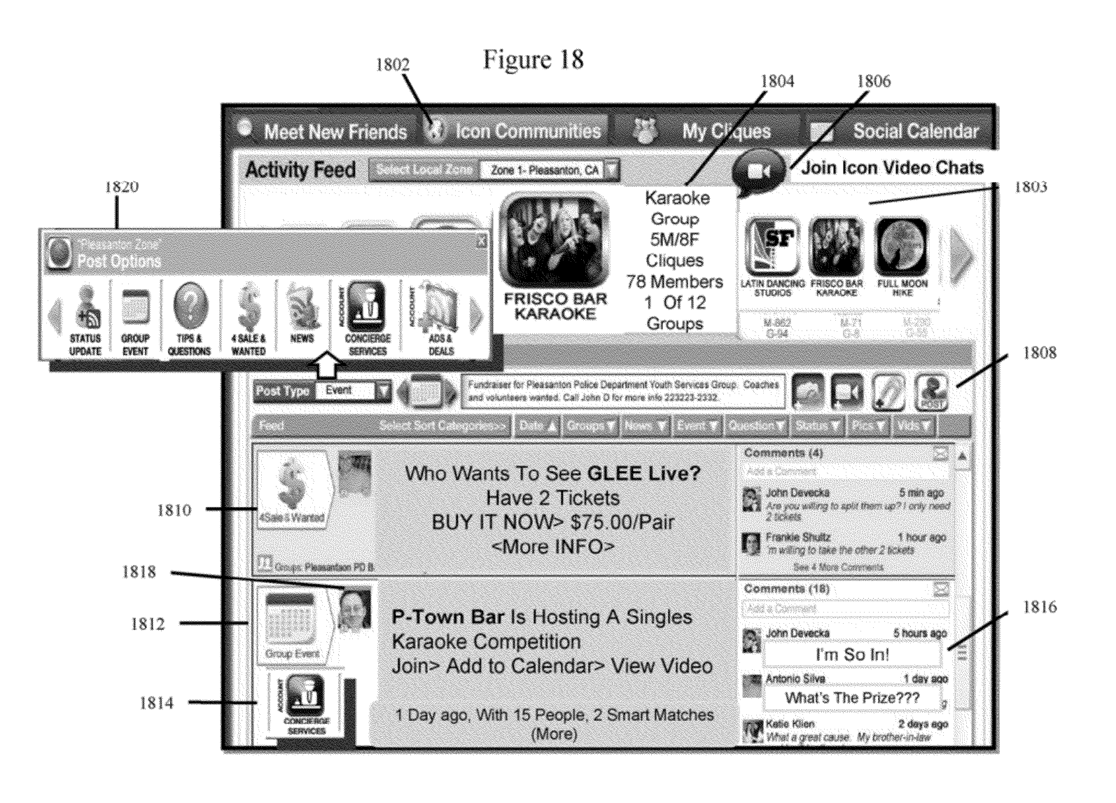

In an embodiment rather than searching and contacting activity potential partners, a user or the system may post an invitation in the associated baseball or tennis icon social community blog under a group invitation post in the social community environment shown in FIG. 18, for others with related baseball or tennis icons. Posting an open group event in this community may attract more potential tennis players for this user's event. This general technique, structure and functionality may be used for any genre of icon posting.

In an embodiment, a listing 1218 of the dating profiles identified in the search results is provided by the dating network icon system. The dating network icon system may be configured to highlight and list the best ranked order overall match icons based on estimated total compatibility and or by the user's selected search and compatibility preferences. In an embodiment, the result 1218 may be prioritized to list the dating profiles for users that are identified as members of a “Smart Clique” 1224 associated with the searcher. In an embodiment, a dating profile may include a compatibility measures or scores 1220 which visually indicates the degree of compatibility via color-coded bars. In an embodiment, the listing 1218 may include a goals indication and description 1222 and/or a proximity indicator 1224 associated with one or more dating profiles identified in the search results.

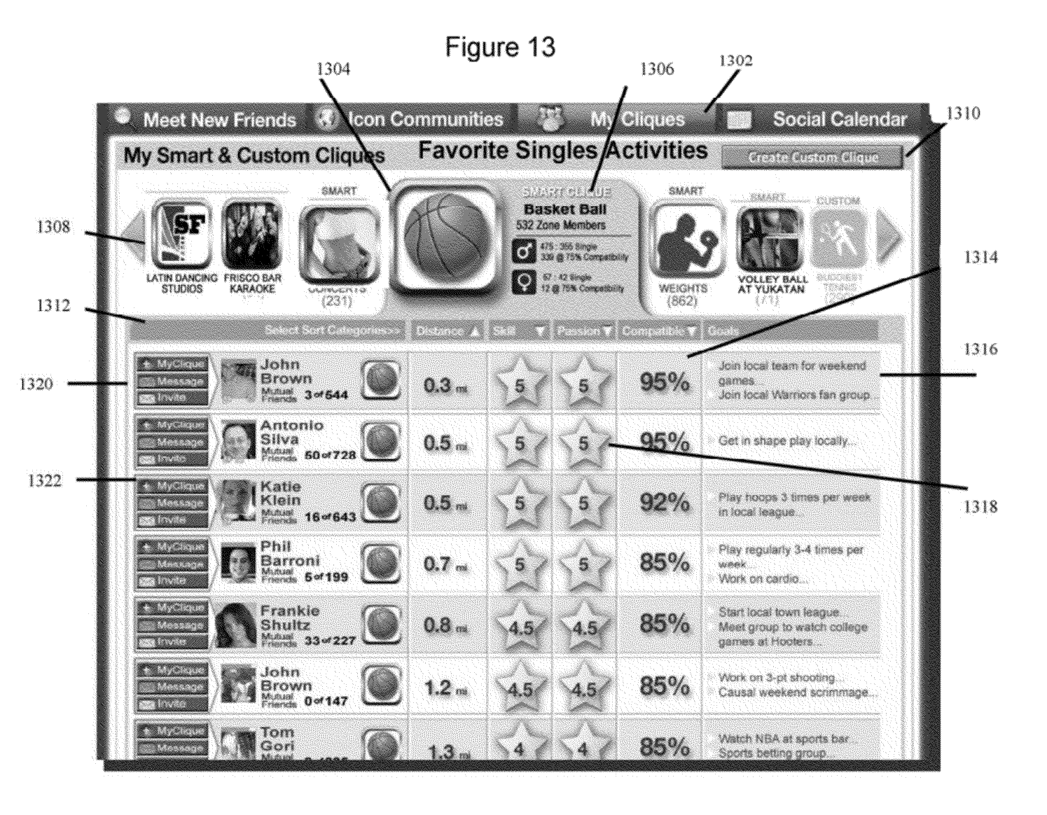

FIG. 13 illustrates an exemplary interface of the dating network icon system displaying exemplary search results generated by the dating network icon system, according to embodiments of the present invention. In FIG. 13, the exemplary search results page results from a search conducted within the “My Cliques” environment 1302 of the dating network icon system. The exemplary user initiating the search is a member of a basketball icon-based smart clique 1304. In an embodiment, the basketball icon-based smart clique header 1306 includes various statistics associated with the clique. The exemplary user is also a member of a number of other smart and/or custom cliques, and may conduct a search for dating profiles within any of the cliques' statistics summary, identified in the scrollable banner 1308 shown in FIG. 13.

In an embodiment, the user may create a custom clique 1310 including one or more of the dating profiles identified in the search results, and the custom clique would be associated with the searcher's dating profile and stored by the dating network icon system.

As shown in FIG. 13, the search result listing may be sorted or ranked by one or more criteria 1312 (e.g., by category, distance, skill indicator, passion indicator, compatibility, goals, etc.). In the exemplary search results listing, a number of different data points and information may be displayed to the searcher, including, for example, a compatibility score 1314 associated with the dating profiles identified in the search results, one or more goals associated with the icon activity and user 1316, a passion or skill level indicator 1318, and a geographic distance between a location associated with the dating profiles identified in the search results.

As shown in FIG. 13, the searcher may take one or more actions with respect to a dating profile identified in the search results, such as, for example, sending a message 1320 or profile or profile summary to a user associated with a dating profile, adding (or inviting a user to join) a user using a “MyClique” link 1322 associated with the user.

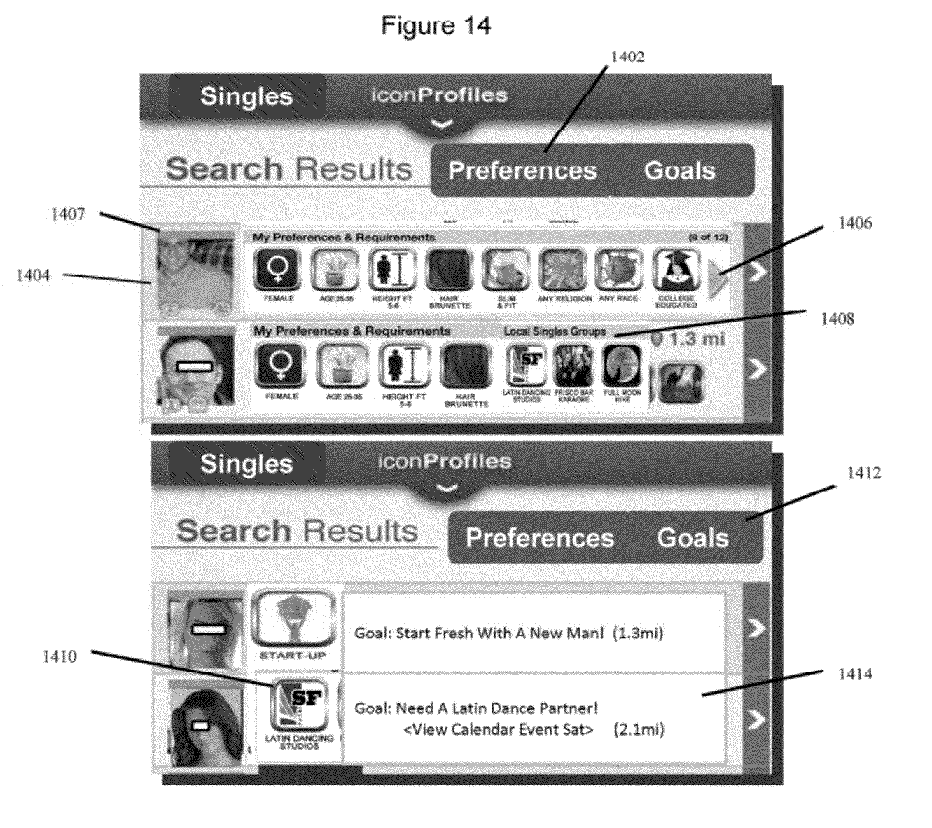

FIG. 14 illustrates exemplary interfaces of a mobile application-based embodiment displaying exemplary search results identified by the dating network icon system in response to search and compatibly criteria including one or more secondary descriptors, according to embodiments of the present invention. The portion of an exemplary interface on the top of FIG. 14 illustrates exemplary search results presented and sorted by the dating network icon system in a preferences-centric view 1402. As shown, each dating profile 1404 may include a secondary indicator (e.g., the compatibility bar 1407 reflecting a level of compatibility) and a corresponding scrollable listing of his or her preferences and requirements 1406 identified and displayed to the searcher to enable the search to identify a user having the desired skill set, expertise, education, and/or local singles groups 1407.

In an embodiment, as shown in FIG. 14, the search results may be presented and sorted by the dating network icon system in a goals-centric view 1412, as shown in a portion of an exemplary interface on the bottom of FIG. 14. As shown, each dating profile is presented with a corresponding listing of his or her goals 1414 associated with an icon (e.g., the Latin dancing studio's icon 1410) identified and displayed to the searcher. In an embodiment, a description of one or more goals 1414 may be provided as part of the search results.

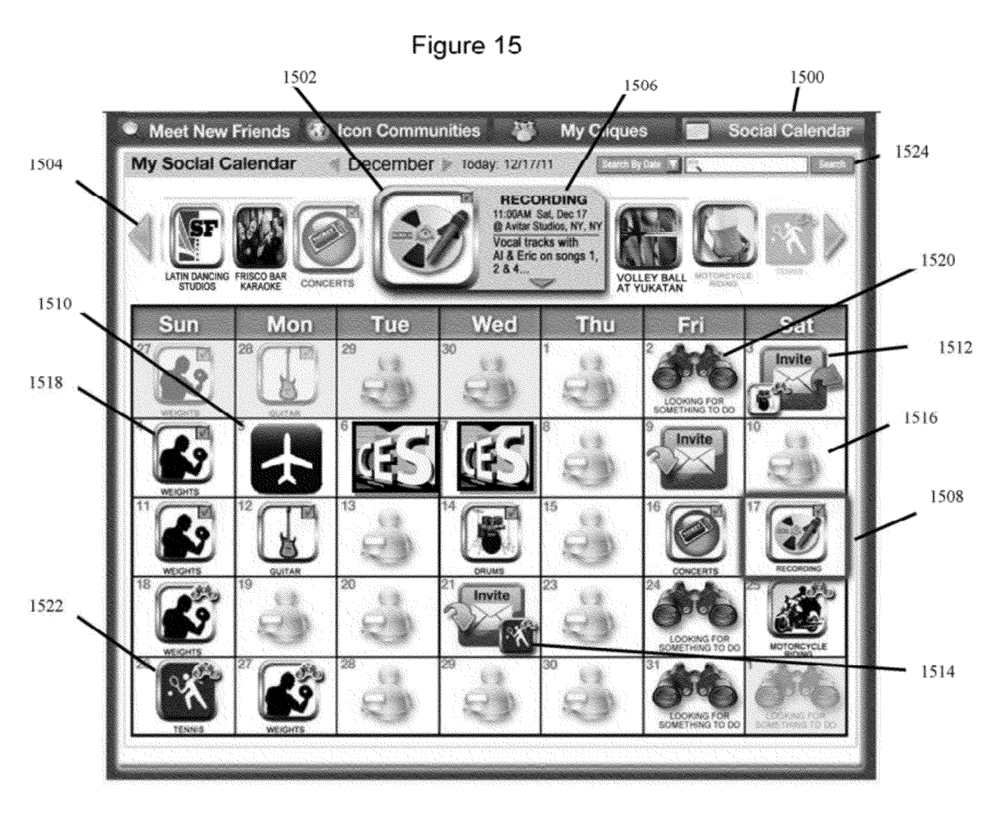

FIG. 15 illustrates an exemplary interface of a dating network icon system displaying an exemplary interactive icon-based social calendar (or “Social Calendar”) 1500, according to embodiments of the present invention. The icon-based social calendar 1500 provides an efficient image-based communication of scheduled events, availability for time slots/dates, and unavailable time slots/dates or private activities 1516 identified by a user and/or the dating network icon system. According to embodiments of the present invention, the social calendar 1500 may be used to view events, view and match open times, schedule dates, group events, concierge services, social network environment activities, and view a new romantic prospect's potential availability.

In an embodiment, a user may add a new social calendar event to his or her social calendar 1500 or review existing social calendar events by selecting an icon (e.g., the “Recording” icon 1502) from the scrollable list of multiple icons 1504 in the dating profile. In this example, the user selects the Recording icon 1502 derived from his profile in order to schedule, highlight or identify any associated events on his or her social calendar. The selected Recording icon 1502 includes a header identifying information 1506 relating to any social calendared events associated with the selected icon. In addition, in this example, the corresponding event 1508 associated with the selected Recording icon 1502 is highlighted in the social calendar.

In another embodiment, the dating network icon system may generate the pop up associated with the Recording related event 1502 in response to a user interact with the date on the social calendar 1500 including the Recording related event (e.g., December 17^{th}). In another embodiment, a current day may be automatically highlighted (e.g., when the current day is December 17^{th}) when the user opens the social calendar and any associated events may be highlighted in a pop up window (e.g., the Recording related event 1502).

As shown, the social calendar 1500 may include multiple icons and various indicators relating to the icons and events. For example, airplane icon 1510 may indicate traveling days whereby the dating network icon system may be configured to locate or notify new friends and activities in the city of travel or more precisely at or near the user's hotel.

In FIG. 15, exemplary social calendar entry 1512 includes an outgoing invitation (i.e., an invitation sent by the user associated with the social calendar) to another user (as indicated by the arrow indicator on the right hand side of the invitation icon) for a drumming related event (as indicated by the drumming icon in the bottom left hand corner of the invitation icon).

In FIG. 15, exemplary social calendar entry 1514 includes an incoming invitation (i.e., an invitation received by the user associated with the social calendar) from another user (as indicated by the arrow indicator on the left hand side of the invitation) relating to a tennis related event (as indicated by the tennis icon in the bottom right hand corner of the invitation icon).

In an embodiment, the social calendar may also contain icons to represent scheduled events, such as a weight lifting workout 1518 which is open to other's participation. By pressing or putting a mouse over icon 1518, a user may view additional secondary details such as, for example, time, location, duration, intensity, other participants, comments, and/or information associated with the workout session. In an embodiment, the social calendar may include an icon 1520 representing a day and/or time the user is available and actively looking for an activity to do with a single friend or potential romantic partner.

Various other indicators may be used in connection with the social calendar to communicate and represent information to one or more viewers of the social calendar 1500, such as, for example, an icon/indicator indicating an open invitation that has not been accepted, an icon/indicator indicating an accepted group activity, a skill level, expertise, a candidate preference type, secondary field preference, etc. associated with a social calendared event. In an embodiment, a user may conduct a search 1524 using one or more keywords and/or icons in order to locate scheduled or pending activity information on the calendar 1500.

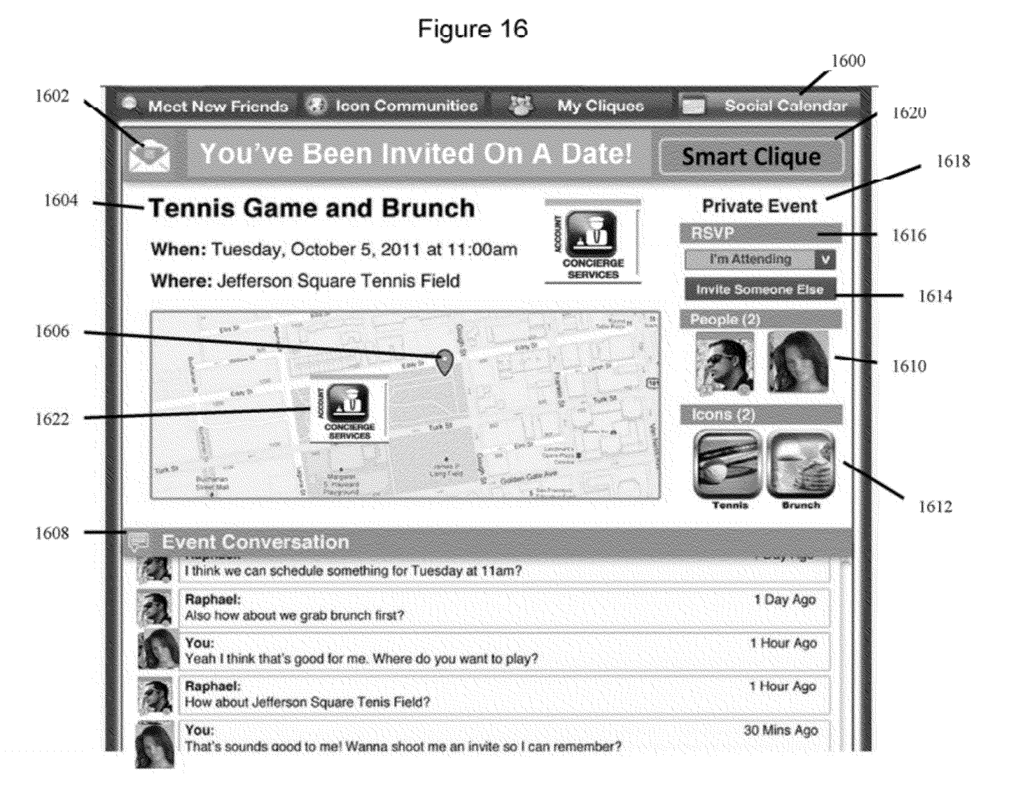

In the example shown in FIG. 15, the user may interact with an icon in the social calendar to view additional information associated with the event and/or access additional functionality of the dating network icon system. For example, if a user clicks on the tennis icon 1522, additional invitation detail relating to the tennis-related event may be displayed to the user, such as the display shown in FIG. 16.

As shown in FIG. 16, an exemplary interface of the icon system is provided which displays an exemplary invitation and chat associated with the tennis and brunch-related date, according to embodiments of the present invention. In the example shown in FIG. 16, the invitation may be viewed with the calendar environment 1600 or system generated match result. As shown in FIG. 16, the exemplary invitation 1602 may include various event/invitation related information including, but not limited to, a name of the event 1604, time of the event, and location of the event, a map identifying the event location 1606, a conversation or chat associated with the event 1608, an indication of the participants in the event 1610, one or more icons representing the type or nature of the event 1612 (e.g., the tennis icon and the brunch icon), an actionable link to invite one or more other users to the event 1614 or RSVP to the invitation 1616, and a privacy setting associated with the event 1618 (e.g., the indication that this is a “Private Event”). In an embodiment, an actionable button may be provided to allow the user to generate a “Smart Clique” 1620 based on the event. In an embodiment, the map may display a concierge services icon 1622 indicating that the brunch portion of the event was related to concierge services offered. reserved, purchased and/or coordinated by the dating network icon system and/or that concierge services are near the location of the event.

Embodiments of the present invention also offer a calendar feature button that determines and presents schedule conflicts by showing a color-coded indicator, for example. A user may open a calendar to view potential conflicts or an icon indicator may provide a free or booked indicator for that time slot. Once accepted, the icon activity is added to the user's calendar publicly or privately and in some cases the user may suggest and forward the activity or event to their friends or others. In an embodiment, a referral icon (not shown) may contain written or unique icon-based activity recommendations or refer a friend to also participate in the event.

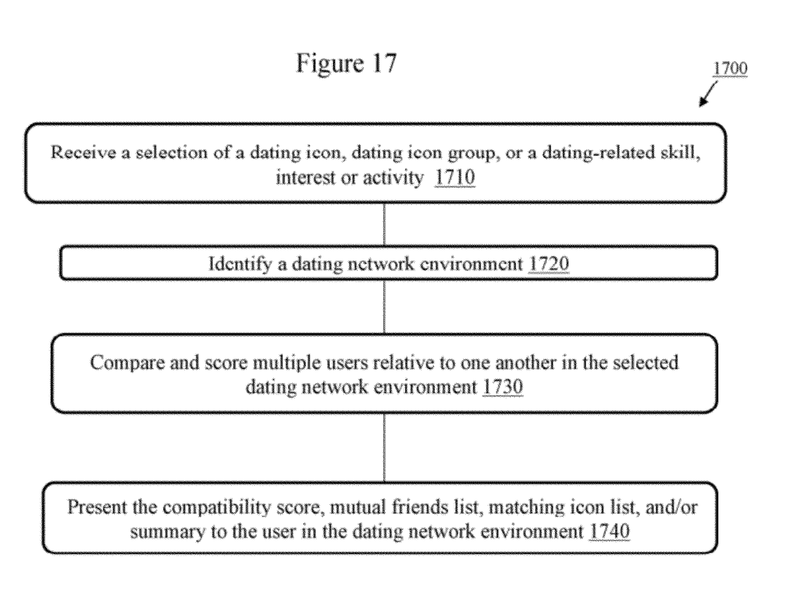

FIG. 17 illustrates an exemplary method 1700 for using a generated icon-based dating profile in multiple dating network environments, according to embodiments of the present invention. In an embodiment, the dating network icon system associates a dating profile with one or more internal environments (i.e., environments within the dating network icon system) and/or external dating network environments (i.e., third party web services and/or applications). In an embodiment, the association and/or integration of the dating profile with the one or more environments may be based on the dating profile's icon community preferences, Smart Clique preferences, matching criteria and/or preferences, and/or the user's zone preferences. In an embodiment, the icons and associated information (e.g., secondary descriptors and user preferences) of a dating profile may be used to determine and present icon or other compatibility of a user with other users in the different environments.

According to an exemplary method 1700, the dating network icon system receives a profile or user selection including a dating icon of interest, a dating icon group, a dating-related skill, interest, activity, or the like, in block 1710. In block 1720, the dating network icon system identifies a dating network environment type with which the user wishes to have his or her dating profile integrated/associated. Exemplary dating network environment types according to embodiments of the present invention include, but are not limited to, a text-based blog or chat, a forum, a video chat or conference, a video or movie viewing platform, a marketplace, a social gaming platform, a singles community, a location-based or local event platform, etc. It is to be appreciated that the dating network environments may be a part of the dating network icon system (i.e., internal environments) or third-party administered services or applications (i.e., external environments accessible via an API).

In an embodiment, the dating network icon system may identify the dating network environment type based on a selection received from the user or the dating network icon system may determine or suggest a dating network environment type that contains other users who have a high compatibility with the particular user. In an embodiment, other user with matching or related icons and icon groups may be aggregated by the dating network icon system into a selected icon community.

In an embodiment, the dating profile may be used to filter or rank the candidate dating network environments for association with the dating profile. For example, the dating profile may include one or more user preferences relating to a desired community size, location, demographic, and those user preferences may be used to filter the candidate dating network environments.

In block 1730, the dating network icon system compares and scores the multiple users in a selected dating network environment based on the dating profiles associated with the multiple users. In an embodiment, the comparison performed by the dating network icon system results in a determination of the mutual compatibility of the users within the community and associated compatibility scores are generated.

In block 1740, the dating network icon system presents one or more of the generated compatibility scores, an environment summary, a matching summary, a mutual friends list, and/or a matching icon list to the one or more users in the dating network environment. In an embodiment, a priority status or other indication may be displayed by the dating network icon system to designate new highly-compatible users, previously confirmed smart clique members, or other previously identified friends.

According to embodiments of the present invention, certain dating network environments (e.g., online gaming communities, video chat communities, etc.) may advantageously use the dating profile viewing, searching, and compatibly display and comparison system to enhance the respective community experience and encourage socialization, singles friendships, and dating networking.

FIGS. 18-20 illustrate examples of the integration and/or association of a dating profile with various dating network environments, according to embodiments of the present invention. FIG. 18 illustrates an exemplary interface of the dating network icon system displaying an exemplary icon based social community billboard blog according to embodiments of the present invention. As shown in FIG. 18, a user may access an icon aggregated community via an “Icon Communities” tab 1802 or similar link provided by the dating network icon system.

In the example shown in FIG. 18, a user selects a “Frisco Bar Karaoke” dedicated icon community 1804 associated with multiple related dating network environments including a video chat environment 1806 and a chat room/bulletin board feed 1808. In an embodiment, a user selects the “Frisco Bar Karaoke” group icon from the toolbar 1803 which contains icon elements from the user's associated icon profile. In this example, the user entered a preferred zone (e.g., Pleasanton, Calif.). In this basic example, the icon element and zone based singles' social community is now aggregated to compile, distribute, sort and rank blog posts and associated content from users with the “Frisco Bar Karaoke” icon in their profile in Pleasanton, Calif.

In an embodiment, this icon community chat/bulletin board feed may be viewed sorted by the user and may include categories of posted content 1820 such as a user privately wanting or selling any item relating to the icon element community 1810 and 1814, a concierge service-related group event integrated with the system's social calendar 1812, and comments 1816 associated with the event 1812. A toolbar 1808 or importing posting content media. As shown, the user may select a desire post type for inclusion in, ranking or filtering of the icon community chat/bulletin board feed 1808 using a “post options” toolbar 1820.

According to embodiments of the present invention, one or more concierge services 1814 may be provided via the dating network icon system. The concierge service may provide a communication system for commercial users of the dating network icon system who intend to generate revenue by soliciting potential customers based on dating profile preferences. In an embodiment, a business or user with related goods and/or services and promotions (herein, a “concierge”) registers with the dating network icon system and may provide localized or potentially nationwide offers to users and icon groups with matching or related icons. Certain embodiments of the present invention may require commercial concierge service providers to pay a fee for advertising access to the user base directly or via the site administrator.

In an embodiment, users may proactively find or request a “push notifications” of concierge services, to the user via a concierge search system. Users may also actively search for, indicate or push their level of interest in offers for each listed interest, brand, thing, travel, or favorite activity which may include food and retail locations. In an embodiment, concierges, advertisements, or offers may be rated, ranked by and shared with other users. For example, highly-rated services, advertisements and/or offers may receive higher priority and more placement opportunities in the dating network icon system. Concierges and/or advertisers may be notified, warned or restricted if their services are rated too low by users or if they send offers unrelated to a user's profile. A commercial user may search and sort the user profile database, as a typical user may for other users who have a shared interest.

In an embodiment, advertisements, coupons, offers, activities, news and other promotions may be administered by the dating network icon system or by a dating network environment based on searching icons, categories, groups, participation, use and other user data in order to target and present this information for the intended demographic. Embodiments of the present invention provide functionality that allows users to rate this information in order to improve the marketplace services. For example, a specialized sorting algorithm may segments icons, secondary descriptors, user preferences, groups, participation, and other data into demographics for advertisers and others to use in presenting their offers. In an embodiment, fees to reach these categorized user groups or for specialized user data summaries may be based on the various factors evident to one having ordinary skill in the art.

In an example, a user may highlight his or her diving hobby icon as an “active interest” and identify secondary icons and tags for their certifications and completed dives. The user may add a new zone in the dating profile prior to or after travel from Denver to Santa Monica and indicate an open social calendar day for this coming Sunday morning. The local concierges and advertisers may be notified of a match via the dating network icon system or a post may be sent to the open diving community feed. In this example, a service vendor may then provide an offer (e.g., a singles-only diving expedition) in the available time slot. In an embodiment, the additional notification feature may be part of a premium account which may increase the monthly access fee for the concierge.

In another example, a user may select a “diving” icon as one of his or her top local traveling interests, thereby increasing the likelihood that a business would send a special concierge offer related to diving. In an embodiment, a user rating may be provided to concierges regarding the quality or frequency of acceptance of a user for posting active interests. In an embodiment, a concierge account may also be operated by an actual person or company who coordinates offers for a wide variety of activities or services. In addition, a concierge may also be associated with a hotel matched by the dating network icon system or in a special hotel community environment accessed by users who travel.

In this example, the registered diving concierges or related advertisers may receive a message derived by a concierge search feature from this user requesting diving offers, or, alternatively, the user may proactively search a concierge database and select the best personality or secondary match, best rated or lowest cost dive master. In an embodiment, selection of a service provider may be based on having strong commonality in other areas and user ratings. In an embodiment, special discounts may be posted or attached to the concierge's dive icon, dive icon community feed or via another means.

In an embodiment, a highlight may be used to indicate an offer for diving has arrived with a pop up window or display, a revealing display tile, an inserted blog advertisement, an email or a text message including the details of the offer. According to an embodiment of the present invention, a credit card may be linked to the user account in order to hold or purchase a service or product offer by pressing a “book it” or purchase icon.

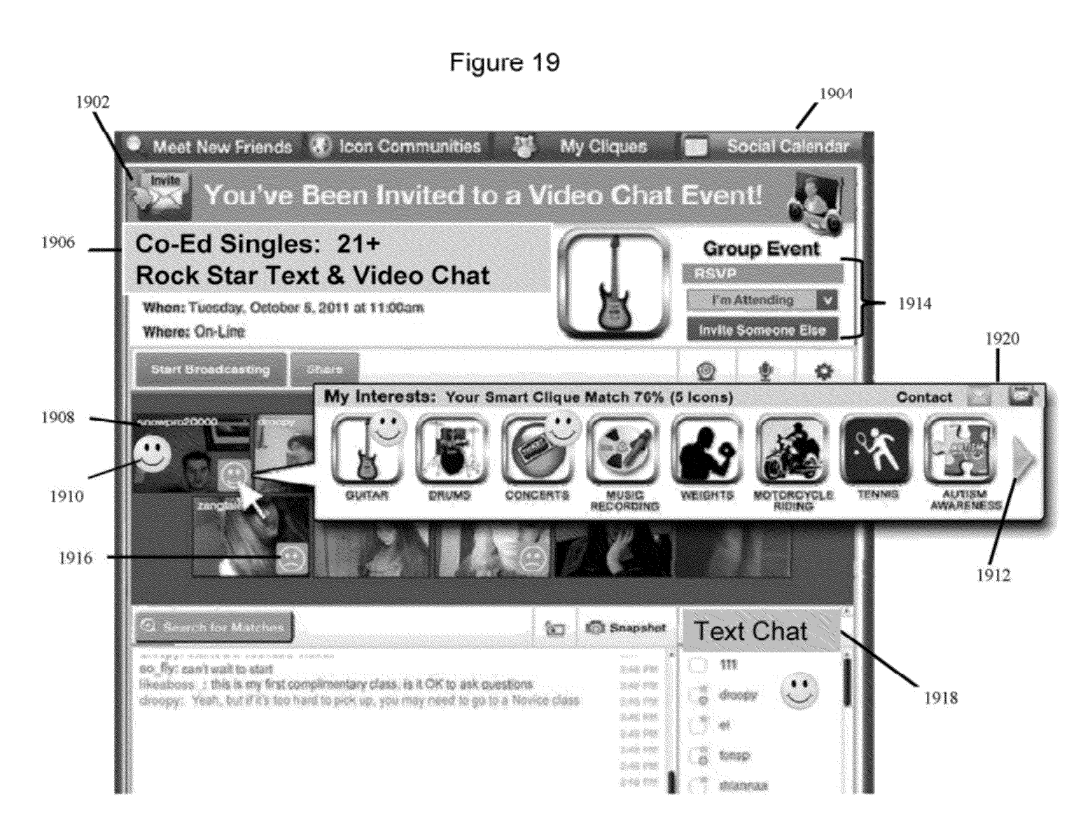

FIG. 19 illustrates an exemplary interface of an icon-based dating network system displaying the integration and/or association of one or more dating profiles in an exemplary video chat or broadcast environment, according to embodiments of the present invention. In an embodiment, the dating network icon system may be configured to associate a dating profile within a dating network environment, such as the video chat environment shown in FIG. 19. As shown in FIG. 19, the video chat functionality may be accessed by a user via a related invitation 1902 which is accessible and linked to the user's social calendar 1904. The exemplary video chat social environment is also provided as a social network menu option found in the icon community menu allowing singles to meet icon chat rooms and determine mutual compatibility in various icon video chat sessions and environments. The video chat may include a header 1906 displaying information about the subject of the video chat and other associated information (e.g., the date and time of a schedule video chat), and/or an indication that the event is from a user, a group or a concierge service.

Live video feeds associated with singles participating in the video chat may be displayed in section 1908. Advantageously, a user may interact with or select to view all or a portion of the participants' dating profile including one or more compatible single friends or dating icon matches as denoted by the smiling face indicator 1910. The dating profile pop up window/display 1920 may include a scrollable list of the icons 1912 in the selected user's dating profile. The dating profile pop up window/display may also a banner having additional information relating to the dating profile, such as, for example, a compatibility score(s), a link for further communication with user (e.g., an e-mail link), etc. In an embodiment, an “emotion” icon 1916 may be used to graphically communicate the other user's compatibility compared to second user (e.g., a smiling face icon represents a positive match while a frowning face icon indicates a low compatibility score between two users).

In an embodiment, the video chat may have an associated text-based chat forum 1918. In addition, the video chat may include one or more fields and/or links which allows a user to RSVP or invite additional users to join the video chat 1914.

In an embodiment, the exemplary invitation and video chat shown in FIG. 19 may be provided to a user in connection with the concierge services provided by the dating network icon system. For example, the concierge services may be configured to send personalized interest and dating-related offers to a user and or gain additional access environments, to tools and data to further sort user data to improve their advertising effectiveness. For example, if a dating profile includes a concerts icon and a secondary descriptor indicating a need for need for tickets to a particular rock concert, a ticket broker may provide a ticket offer to the user via the invitation 1902 shown in FIG. 19. In so doing, the concierge (e.g., the ticket broker) may utilize any additional secondary descriptor information in providing the offer, including but not limited to, a user's previous concert going activity, upcoming dating schedule, icon communities, forums and events.

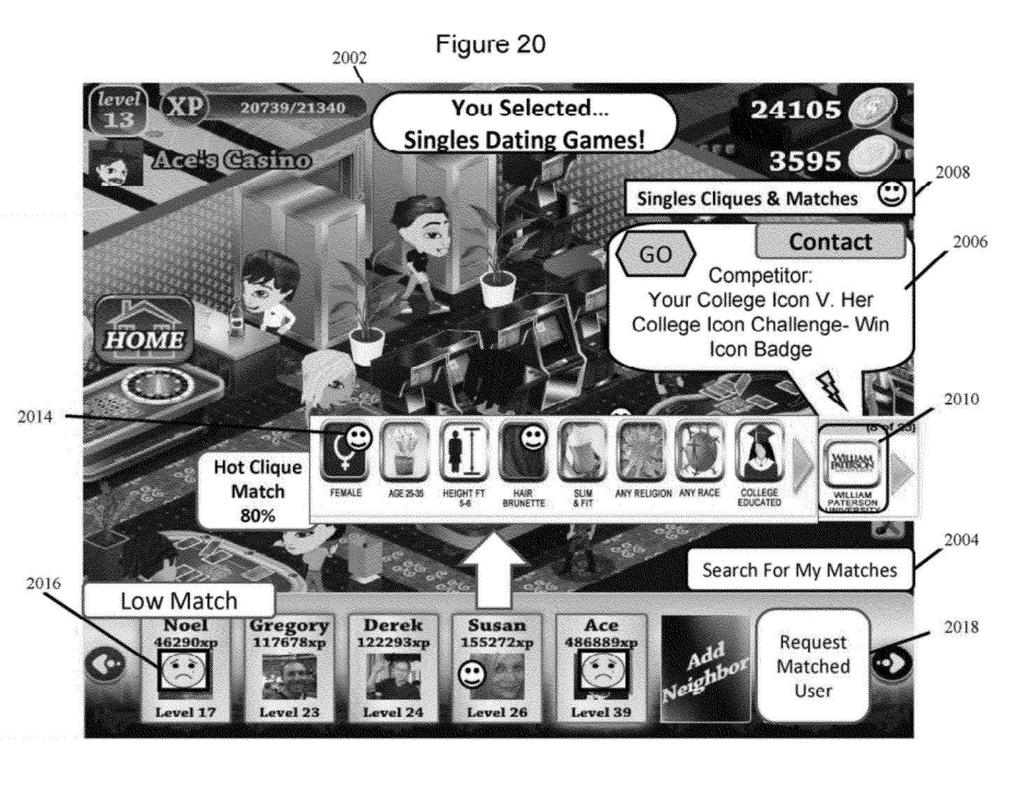

FIG. 20 illustrates an exemplary interface of the dating network icon system displaying the integration and/or association of a dating profile in an exemplary gaming environment, according to embodiments of the present invention. As shown in FIG. 20, a dating profile may be integrated into an internal and/or external social gaming environment 2002. In an embodiment, the gaming environment 2002 is specifically configured for “singles” and includes multiple dating network icon system users and their associated dating profiles.

In an embodiment, a user may interact with any of the dating profile images shown in the bottom portion of the gaming environment display in order to view the user's associated dating profile. In the example shown, the player was notified that player “Susan” was highly compatible. After selecting player “Susan”, a corresponding pop up display is generated including a summary of the selected user's dating profile including associated compatible icons. In some gaming communities, dating profiles and matching icons may be displayed to increase personal connection and understanding. In other gaming applications and communities, dating profiles and data may be integrated into the game experience.

As shown in the pop up window/display associated with Susan, a viewer may visually determine that he or she has a common University graduate icon 2010 and a positive compatibility indicator 2014 with respect to the viewer's single friend or dating candidate preference for a female and a brunette, thereby providing a potential basis for further interaction and a potential relationship or connection with Susan. In the match list section 2004, a viewer may also visually identify the users in the gaming environment with which they are compatible (as indicated by the smiling face indicator) and/or users in the gaming environment with which they are not compatible or have a low match (as indicated by the frowning face icon 2016). In an embodiment, a user may interact with a “Request Matched User” icon 2018 in order to search for and invite alternate matched users or selected specific icon elements associated with other users, within the this community environment.

In an embodiment, the dating profile within the gaming community may also contain many gaming-specific categories and icons as noted in gaming culture, such as, for example, favorite video games, genres, favorite gaming characters, high scores, gaming achievements, favorite gaming events, gaming groups, and other gaming genre preferences. In addition, social gaming environments may also match players together based on icon compatibility and player matching preferences. In other applications, dating profiles and data may be incorporated directly into game play and competition.

In this example, the dating network icon system displays a section of a user's profile icons whereby certain game mechanics include profile analysis to encourage increased competition or cooperation potentially based on icon dating profile elements. In an embodiment, icon 2006 indicates there is a potential or existing competitive challenge based on a matched dating icon relating to a user's educational background (e.g., the college the user attended/attends). The viewing user and Susan may have different and potentially “competitive” sub-icons associated with their college affiliation.

In an embodiment, scores or badges may be presented based on past competitive performance within one or more gaming environments. In an embodiment, players may also be linked together collectively as a group based on dating network icon system-generated or user-generated created icons or icon associations or elements to compete or perform a task in order to win status points and/or perks for their association.

In this example, the user may accept a challenge to compete against the other player by pressing the “Go” button. The challenge may be related to the actual icon interest such as college vs. college academic trivia game or be more associated with the theme and mechanics of the video game. The users may also communicate verbal challenges, comments and virtual bets to each other to enhance the competitive environment.

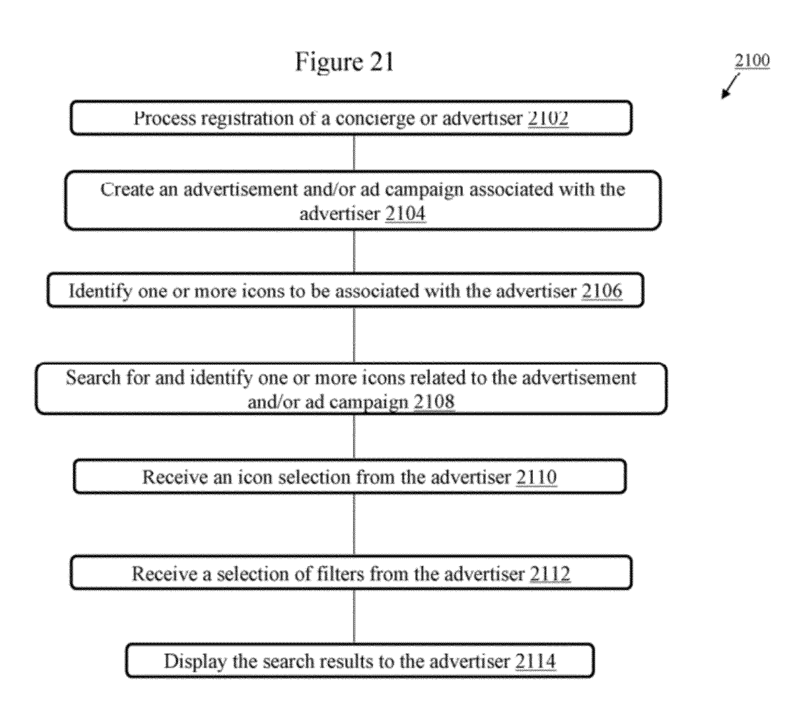

FIG. 21 illustrates an exemplary method 2100 for creating and/or delivering a concierge service or advertisement within the dating network icon system, according to embodiments of the present invention. In block 2102, the dating network icon system processes a registration of a concierge and/or an advertiser (collectively referred to as an “advertiser” in the description of FIG. 21). During the registration process, the advertiser may select one or more dating network genres of interest (i.e., genres to which the advertisers wishes to direct advertisements).

In block 2104, the dating network icon system receives information from the advertiser and creates an advertisement and/or advertisement campaign associated with the advertiser. In an embodiment, the advertisement is created by the advertiser and posted and/or uploaded to the dating network icon system. In another embodiment, the dating network icon system provides the advertiser with a tool configured to enable the advertiser to create the advertisement with the dating network icon system. The advertisement may be defined by various ad parameters including, but not limited to, a media type, a design, description, format, and the like.

Using an advertisement search module of the dating network icon system, the advertiser may select one or more icons from the icon library with which the advertiser wishes to be associated. The selected icons may be used as a basis for directing one or more advertisements from the advertiser. In response, the dating network icon system identifies the selected icon(s) and associates the selected icon(s) with the advertiser, in block 2106.

In block 2108, the dating network icon system searches for and identifies one or more icons related to the advertisement and/or the ad campaign, and presents the identified icons to the advertiser. In block 2110, the dating network icon system receives a selection of an icon from the advertiser and provides information relating to the selected icon to the advertiser (e.g., icon tags, icon description, icon statistics, icon keywords, etc.).

Optionally, in block 2122, the dating network icon system may receive filtering information from the advertiser. For example, the filtering information may include, but is not limited to, one or more icons or sub-icons, a geographic zone, a status (e.g., “Fan”, “Participant”, etc.), a skill level, a passion level, one or more goals, an advertiser, social calendar events, branding information such as “my trade tools”, and user preferences (e.g., any user preference associated with accepting advertisements and/or concierge services).

In block 2114, the dating network icon system displays the search results including one or more dating profiles, icons, icon communities, cliques, events, and the like to the advertiser. According to embodiments of the present invention, the advertiser may perform various actions with regard to the search results provided by the dating network icon system. In an embodiment, the advertiser may select particular dating profiles, icon communities, events, and/or cliques to serve as recipients or intended targets of the advertisement and/or ad campaign. Optionally, the advertiser may eliminate or remove one or more of the elements included in the search results. In an embodiment, the advertiser may review one or more of the dating profiles identified in the search results.

In block 2116, the dating network icon system receives a selection of one or more advertisement placement parameters from the advertiser. The advertisement placement parameters define the specifics regarding the manner in which the advertiser wishes to distribute the advertisement (e.g., how, where, when, and to whom the advertisement should be distributed). Exemplary advertisement placement parameters include, but are not limited to, a placement method, a location, a user's icon element, a distribution date, a campaign duration, one or more target dating profiles, one or more target icon communities, one or more target genres, one or more target dating network communities, and one or more target events. One having ordinary skill in the art will appreciate that other advertisement placement parameters may be used in accordance with embodiments of the present invention. Advertisers may receive an estimated fee or other cost options associated with their selected parameters. In an embodiment, the dating network icon system may be configured to allow users to comment on and/or rate an advertisement, advertiser, and/or concierge service.

According to an embodiment of the present invention, users may earn points, icon badges, status or credits for using or redeeming offers associated with advertisements, taking surveys or voting within the system or in other ways, possibly in lieu of paying a monthly fee for the service. As described above, advertisements, news and/or promotions may be placed on screens relating to a selected icon or group or community.

In an embodiment, a user may routinely and dynamically change his or her profile icons based on their past activity schedule, seasonality, evolving preferences, location, and changing lifestyle. Notifications of these icon profile changes or status changes may be pushed to friends or into the general icon news feed. Friends in this system may also be automatically categorized, matched or organized based on usage or communication frequency. For example, top activity or compatibility matches and friends may be ranked for each icon, online community or group. Status updates or communications from those users may have high priority in the feed. For example, a match or friend statistics view may provide a list of friends for an activity, organized by an indicator presenting how many times they accepted an invitation for that icon activity.

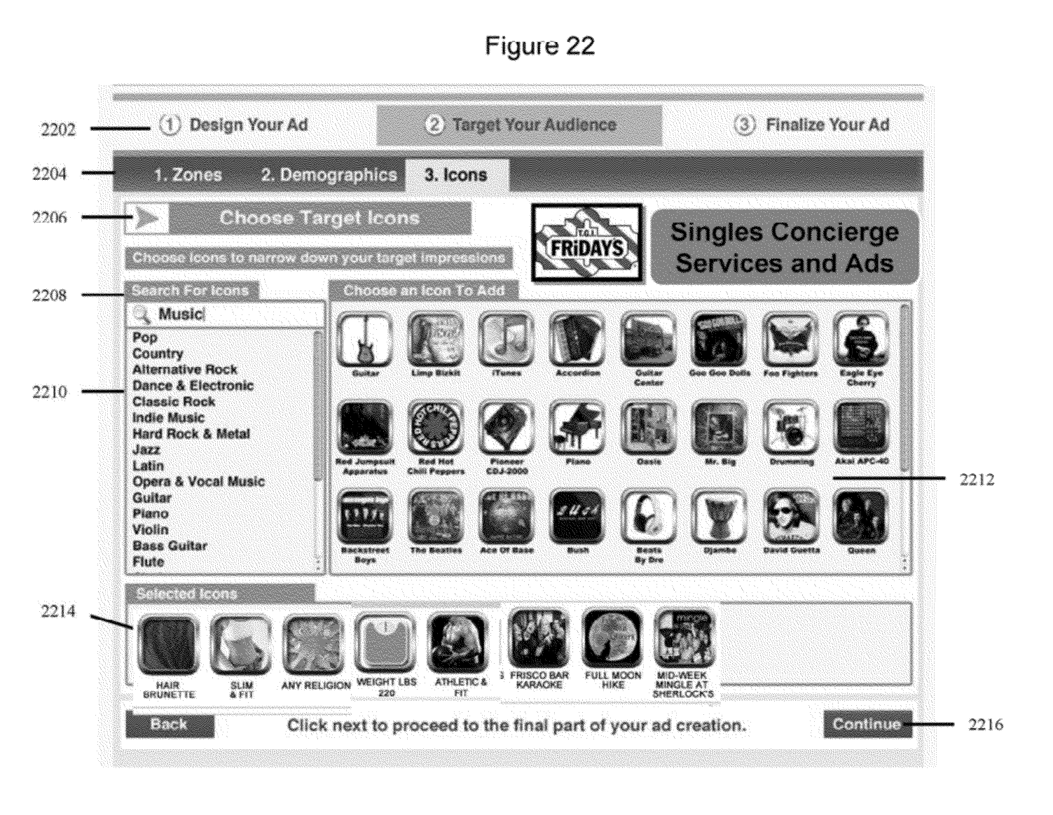

FIG. 22 illustrates an exemplary interface of the dating network icon system displaying an exemplary advertisement creation and delivery tool 2202, according to embodiments of the present invention. As shown in FIG. 22, an advertiser may select one or more of a zone, demographics and/or target icons 2204 for use in connection with the creation and distribution of an advertisement (e.g., a T.G.I. Friday's ad) and/or an ad campaign. In the example shown in FIG. 22, the advertiser is presented with the “Choose Your Target Icons” functionality 2206 for use in selecting one or more icons for use in targeting users of the dating network icon system.

In an embodiment, the advertiser may select from and/or search for a number of icon categories 2208 associated with a genre. In this example, multiple genres 2210 are presented to the advertiser based on the advertiser's search music-related icons. Upon a selection of a “music” genre or icon from the genre and/or icon listing 2210, a pallet of related icons 2212 is presented to the advertiser. From the pallet of related icons 2212, the advertiser may choose one or more icons to add to the targeting criteria for the advertisement and/or ad campaign. The one or more icons selected by the advertiser are displayed in a “Selected Icons” 2214 portion of the display. Following selection of the icon selection as part of the targeting criteria process, the advertiser may click a “Continue” button 2216 to proceed with the advertisement creation method.

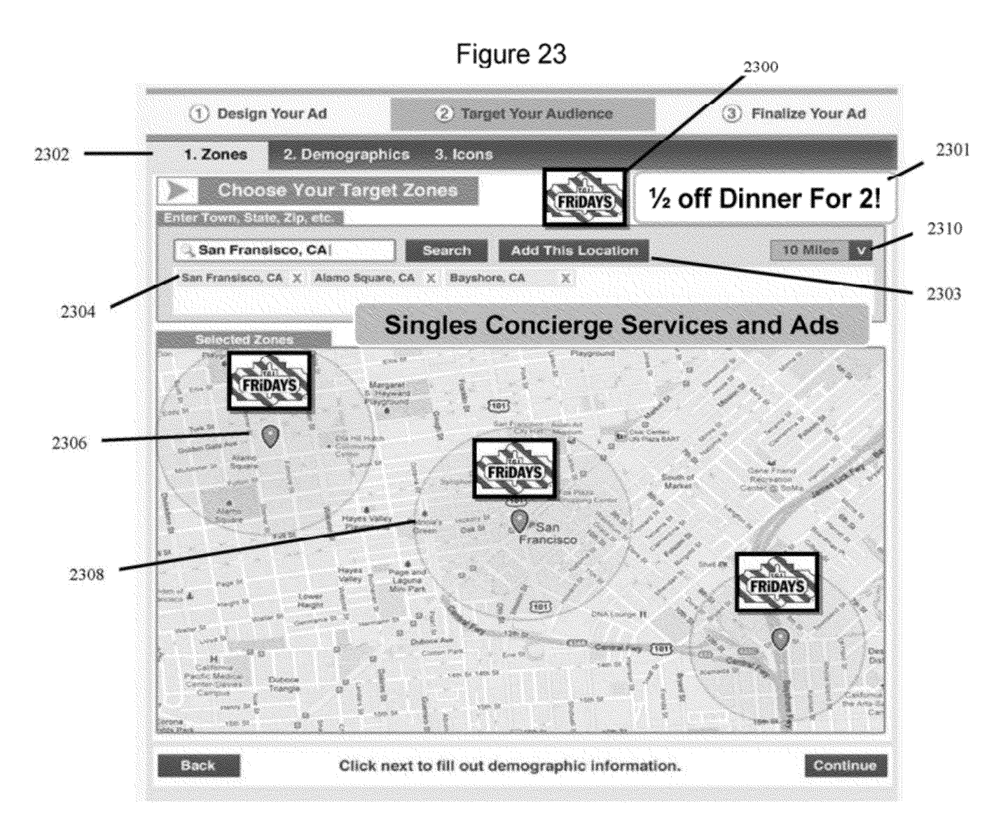

FIG. 23 illustrates an exemplary interface of the dating network icon system displaying an exemplary advertising delivery tool, according to embodiments of the present invention. As shown in FIG. 23, the advertiser (e.g., T.G.I. Fridays 2300) may select and adjust one or more zones (or geographic areas) 2302 as part of the targeting criteria for the advertisement and/or ad campaign 2301 by interacting with an actionable button, such as the “Add This Location” button 2303. In an embodiment, the advertiser may enter multiple zones in a selected zone field 2304 and/or on a corresponding map. As shown, a specified location may be identified by an indicator 2306 and a corresponding zone or region surrounding the specified location (e.g., zone 2308). In an embodiment, the advertiser may specify the size of the zone or region surrounding the specified location using, for example, the zone indicator drop down menu 2310.

According to an embodiment of the present invention, users have the ability to block feeds from other members or narrow blogs and feeds to reduce or increase the length or number of posts of that feed via filters and zones. In an embodiment, the dating network icon system may also automatically perform those functions to provide the optimal community and information size. Users may also search and view previous news, blogs and update feeds that are saved by the system from a previous time. In another embodiment, customized groups may be created within an icon category. For example, a motorcycle icon online sharing community may contain subgroup forum memberships for Harley Davidson enthusiasts and custom chrome modifications which are created and promoted for other's to join in order to share information, media, news, blogs and posts specifically related to that subtopic. Those groups may be part of their own online community or share the community with all motorcycle genre icons but posts may be distinguished with their icon and as coming from a member of that subset.

In an embodiment, a user may display all of the groups the user is either actively participating in, following or has participated in, by, for example, clicking on the “My Cliques” tab shown in FIG. 3. With regard to the cliques or groups, a user may be identified as a “Member or Founder”, thereby indicating which groups a person has led or leads, or is simply a member. In an embodiment, private groups or invitation-only groups may be created.

Furthermore, the dating network icon system may also be configured to suggest complimentary icon matches or icon groups or activities. For example, a user with an “actor” icon in his or her dating profile may be suggested to join a local theater group or Icon. The search and matching system and algorithms according to embodiments of the present invention may allow for varying compatibility requirements and interpretation based on available aggregated user data. In some cases, users may be interested in learning something new, a new style of an activity or trying a completely new adventure, interest or select less compatible matches. According to embodiments of the present invention, if several of a user's important or prioritized icons suggest or have associated tags for a certain personality trait (e.g., a trait of an adventurous personality), the dating network icon system may be configured to suggest other related interests, icon elements and communities, such as, for example, skydiving or mountain biking along with the associated smart clique or user match results. Also if user data demonstrates that a majority of people who strongly like skydiving also strongly like racing motorcycles, the dating network icon system may suggest that associated interest for possible inclusion by the user in his or her dating profile.

According to embodiments of the present invention, activities/interest may be best suited for one-on-one participation by the users or require a group or certain minimal level of participation which may be set as required or preferred criteria for a group event. For example, group activities requiring 3 or more users may include motorcycle riding, playing basketball game, or a hiking trip. In an embodiment, the minimum level of participants may be a requirement for the activity to commence.

In embodiments, users may check into icon activities and events allowing other users to potentially locate and join them. According to an embodiment of the present invention, the dating network icon system may create an activity history log and rating, with user comments and added media that may be viewed by the user or other members within the community. In an embodiment, users may earn status, icon badges, in-community status or perks for the number of check-ins for their icon activities or for sending invitations to other members. For mobile users with existing profiles, games may be offered for in-person connections. In an embodiment, users may sync up with local members at a gathering, play trivia games based on a profile data or various compatibility algorithmic results may be offered including local matching of friends, business or those looking for relationships.

According to an embodiment of the present invention, users may initiate a trivia game, for example, provided by the dating network icon system or an application based on their icons, dating profile, and/or user preferences, whereby friends or acquaintances may be challenged about trivia derived from their unique dating profile data. Scores, credits and awards may be given to determine who has the most knowledge about a person or may guess how compatible users are as determined by the system. In an example, the game may be played in person and given as a challenge at a function or party via a mobile device. Any media from that event may be sent and stored for the participants to view or post to the community.

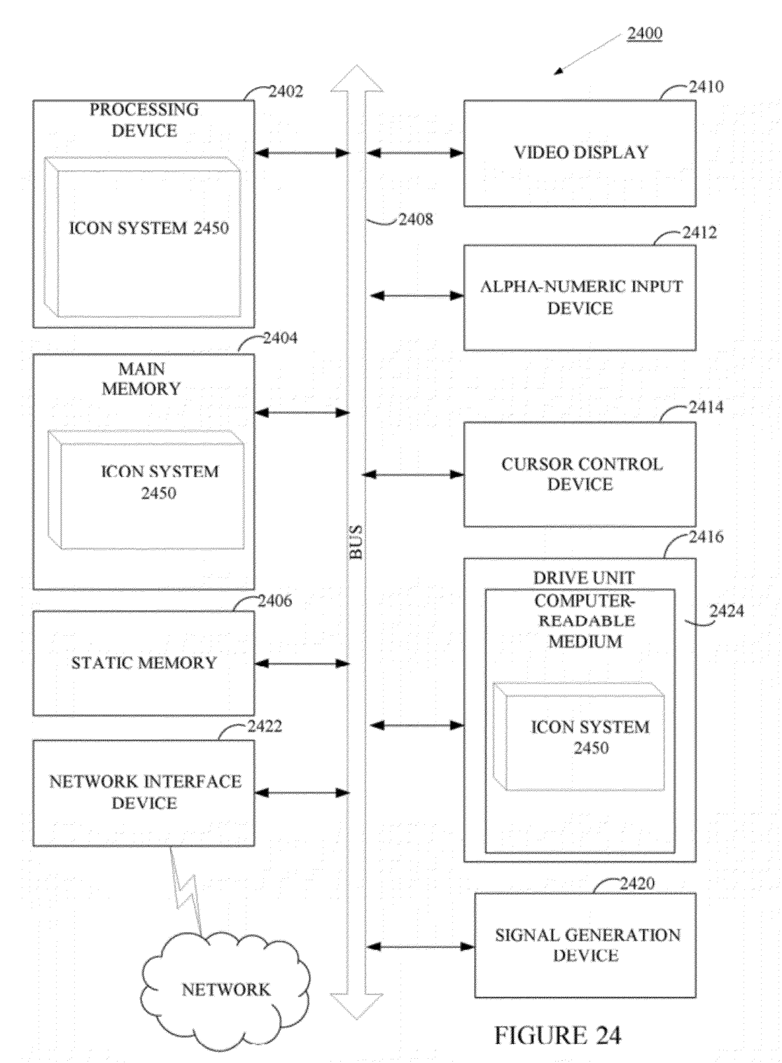

FIG. 24 illustrates a diagrammatic representation of a machine in the exemplary form of a computer system 2400 within which a set of instructions, for causing the machine to perform any one or more of the methodologies discussed herein, may be executed. In some embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 2400 includes a processing device (processor) 2402, a main memory 2404 (e.g., read-only memory (ROM), flash memory, dynamic random access memory (DRAM) such as synchronous DRAM (SDRAM)), a static memory 2406 (e.g., flash memory, static random access memory (SRAM)), and a data storage device 2416, which communicate with each other via a bus 2408.

Processing device 2402 represents one or more general-purpose processing devices such as a microprocessor, central processing unit, or the like. More particularly, the processing device 2402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 2402 may also be one or more special-purpose processing devices such as an application specific integrated circuit (ASIC), a field programmable gate array (FPGA), a digital signal processor (DSP), network processor, or the like. An dating network icon system 2450 may be provided which is configured to perform the steps, operations, instructions, and functions described in detail in the present application. The dating network icon system 2450 may comprise processing device 102 configured to perform the operations and steps discussed herein.

The computer system 2400 may further include a network interface device 2422. The computer system 2400 also may include a video display unit 2410 (e.g., a liquid crystal display (LCD) or a cathode ray tube (CRT)), an alphanumeric input device 2412 (e.g., a keyboard), a cursor control device 2414 (e.g., a mouse), and a signal generation device 2420 (e.g., a speaker).

A drive unit 2416 may include a computer-readable medium 2424 on which is stored one or more sets of instructions (e.g., instructions of an dating network icon system 2450) embodying any one or more of the methodologies or functions described herein.

In an embodiment, the dating network icon system 2450 may be a software component (i.e., a set of instructions executable by a processing device of the computer system 100, such as processing device 102) configured to perform the actions, functions, steps, processes, procedures, etc. described in detail in the present application.

The instructions of the dating network icon system 2450 may also reside, completely or at least partially, within the main memory 2404 and/or within the processing device 2402 during execution thereof by the computer system 2400, the main memory 2404 and the processing device 2402 also constituting computer-readable media. The instructions of the dating network icon system 2450 may further be transmitted or received over a network via the network interface device 2422.

While the computer-readable storage medium 2424 is shown in an exemplary embodiment to be a single medium, the term “computer-readable storage medium” should be taken to include a single non-transitory medium or multiple non-transitory media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “maintaining”, “receiving”, “generating”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method, comprising:
maintaining a plurality of icons, wherein each icon represents a dating profile element;
receiving a selection of a plurality of icons from a first user; and
generating a first dating profile for the first user based on the plurality of selected icons.

2. The method of claim 1, further comprising receiving, from the first user, secondary descriptor information associated with at least one dating profile element associated with at least one of the plurality of selected icons.

3. The method of claim 2, wherein the secondary descriptor information comprises at least one a skill level indicator, a passion level indicator, an experience level, a goal, a method of contact, an invitation method, an approval counter, a concierge preference, a privacy preference, an advertising preference, a search term, a tag, a media file, a status update preference, a zone preference, a preference relating to receipt of an update, and a brand preference.

4. The method of claim 2, further comprising storing the secondary descriptor information in association with the at least one dating profile element associated with the at least one of the plurality of selected icons.

5. The method of claim 2, further comprising:
receiving, from a second user, a selection of one of the plurality of selected icons of the first dating profile; and
providing the secondary descriptor information associated with at least one dating profile element of the first dating profile to the second user.

6. The method of claim 2, further comprising restricting access to the secondary descriptor information by the second user based on a preference of the first user.

7. The method of claim 5, further comprising receiving a connection communication, from the second user, associated with the at least one dating profile element of the first dating profile.

8. The method of claim 1, further comprising:
comparing the first dating profile and a second dating profile associated with a second user in a compatibility function.

9. The method of claim 1, further comprising:
generating a compatibility score based on a comparison of the first dating profile and a second dating profile associated with a second user.

10. The method of claim 1, further comprising aggregating a plurality of users into a dating community environment based on one of the plurality of selected icons from the first dating profile.

11. The method of claim 1, wherein at least one dating profile element of the first dating profile comprises a communication preference associated with the at least one dating profile element.

12. The method of claim 11, further comprising delivering an icon-specific communication from the second user to the first user in accordance with the communication preference.

13. The method of claim 12, wherein the icon-specific communication is associated with a calendar function.

14. The method of claim 1, further comprising displaying at least one of the selected icons and associated secondary information on a calendar associated with the first user.

15. The method of claim 14, further comprising:
displaying, in association with the calendar, a toolbar comprising one or more of the plurality of selected icons of the first dating profile;
receiving a selection of one of the plurality of selected icons of the first dating profile; and
displaying, on the calendar, an event associated with the selected one of the plurality of selected icons of the first dating profile.

16. The method of claim 1, further comprising receiving, from the first user, a selection of a dating network community type.

17. The method of claim 16, further comprising configuring the plurality of icons and associated category information based on the selected dating network community type.

18. The method of claim 1, further comprising connecting the first dating profile with one or more dating network environments.

19. The method of claim 18, further comprising:
comparing the first dating profile to a second dating profile associated with a second user;
generating a compatibility result associated with the first user and second user; and
displaying the compatibility result to the first user and the second user.

20. The method of claim 1, further comprising:
receiving search criteria from an advertiser; and
providing the advertiser with information associated with one or more of the plurality of selected icons of the first dating profile based on the search criteria.

21. The method of claim 20, further comprising delivering an advertisement from the advertiser to the first user.

22. The method of claim 1, further comprising receiving an advertising preference from the first user associated with one or more of the plurality of selected icons of the first dating profile.

23. The method of claim 1, further comprising:
comparing the first dating profile with a set of user profiles maintained in a searchable database;
generating a search result; and
displaying the search result in association with the first dating profile.

24. The method of claim 23, wherein the comparing is based on at least one icon of the first dating profile.

25. The method of claim 23, wherein the comparing is based on one or more common icons shared by the first dating profile and the set of user profiles.

26. The method of claim 23, wherein the comparing is based on secondary descriptor information associated with the first dating profile and the set of user profiles.

27. The method of claim 23, wherein the comparing is based on a zone associated with the first dating profile and the set of user profiles.

28. The method of claim 23, wherein the comparing is based on one or more compatibility preferences selected by the first user.

29. The method of claim 23, wherein the search result comprises one or more compatibility scores.

30. The method of claim 23, further comprising generating a compatibility smart clique score associated with the first dating profile and a second dating profile associated with a second user.

31. The method of claim 30, wherein the compatibility smart clique score is based on one or more search icons received from the first user and at least one additional common icon comprised in the first dating profile and the second dating profile.

32. The method of claim 23, further comprising generating a plurality of compatibility smart clique scores associated with the first dating profile and a set of other user profiles.

33. The method of claim 1, further comprising integrating the first dating profile into one or more external dating network environments via an API.

34. The method of claim 1, further comprising providing a blog associated with one or more of the plurality of selected icons.

35. The method of claim 1, further comprising:
receiving, from the first user, at least one of an image, a video, an icon animation or an icon description; and
generating a custom icon based on the at least one of an external image, a video, an icon animation or an icon description.

36. The method of claim 35, further comprising adding the custom icon to a library comprising the plurality of icons.

37. The method of claim 36, further comprising:
receiving, from a second user, a selection of search criteria comprising the custom icon; and
matching the first user and the second user based on the custom icon.

38. The method of claim 35, further comprising receiving, from the first user, secondary descriptor information associated with the custom icon.

39. The method of claim 1, further comprising associating one or more tags with the first dating profile.

40. The method of claim 1, further comprising associating the one or more tags with at least one of a search engine and a compatibility engine.

41. A method comprising:
maintaining a plurality of icons, wherein each icon represents a dating profile element;
receiving a selection of a plurality of icons from a first user;
storing personalized information from the first user associated with one or more of the plurality of selected icons;
generating a first dating profile for the first user based on the plurality of selected icons; and
adding the first dating profile to a searchable database comprising a plurality of user profiles.

42. The method of claim 41, further comprising:
receiving, from the first user, search criteria;
conducting a search of the searchable database based on the search criteria; and
identifying one or more of the plurality of user profiles based on the search criteria.

43. The method of claim 42, further comprising reporting a compatibility result comparing the first dating profile and one or more of the identified plurality of user profiles.

44. The method of claim 43, further comprising receiving a connection request from the first user associated with one or more of the reporting a compatibility result comparing the first dating profile and one or more of the identified plurality of user profiles.

45. The method of claim 41, further comprising receiving a selection of a dating network environment type.

46. The method of claim 45, wherein the dating network environment type comprises at least one of a blog, a billboard, a video-based system, social gaming system, and an external API dating network.

47. A computing device comprising:
a memory; and
a processing device coupled to the memory, wherein the processing device is configured to:
maintain a plurality of icons, wherein each icon represents a dating profile element,
receive a selection of a plurality of icons from a first user, and
generate a first dating profile for the first user based on the plurality of selected icons.

48. A non-transitory computer-readable storage medium including instructions that, when executed by a processing system, cause the processing system to perform a method for dating networking, the method comprising:
maintaining a plurality of icons, wherein each icon represents a dating profile element;
receiving a selection of a plurality of icons from a first user; and
generating a first dating profile for the first user based on the plurality of selected icons.
